(19) United States
(12) Patent Application Publication
(10) Pub. No.: US 2016/0364161 A1
(43) Pub. Date: Dec. 15, 2016

(54) EXTERNAL DEVICE OPERATING METHOD AND ELECTRONIC DEVICE SUPPORTING THE SAME

(71) Applicant: Samsung Electronics Co., Ltd., Suwon-si (KR)

(72) Inventor: Sang Bum HAN, Suwon-si (KR)

(21) Appl. No.: 15/165,283

(22) Filed: May 26, 2016

(30) Foreign Application Priority Data
Jun. 15, 2015 (KR) 10-2015-0084226

(51) Int. Cl. G06F 3/06

(52) U.S. Cl. CPC G06F 3/0619; G06F 3/065; G06F 3/067; G06F 3/0659

(57) ABSTRACT

An electronic device is provided. The electronic device includes a memory for storing device objects corresponding to external devices and a processor operatively connected to the memory. The processor outputs some of the device objects based on information related to control of the external devices, receives an input for selecting a device object from among some of the device objects, and generates action group information by grouping pieces of action information for instructing external devices corresponding to the selected at least one device object to perform a specified operation.

### CROSS-REFERENCE TO RELATED APPLICATION(S)

This application claims the benefit under 35 U.S.C. §119(a) of a Korean patent application filed on Jun. 15, 2015 in the Korean Intellectual Property Office and assigned Serial number 10-2015-0084226, the entire disclosure of which is hereby incorporated by reference.

### TECHNICAL FIELD

The present disclosure relates to control of operation of an external device.

### BACKGROUND

Electronic devices support various user functions. For example, electronic devices provide functions of establishing communication channels to external devices and controlling (e.g., turning on or off) the external devices.

As the number of external devices increases, an electronic device is required to have various interfaces in relation to control of the external devices. However, users who are not accustomed to such interfaces for controlling a number of external devices may experience difficulty in using relevant functions.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an external device operating method for facilitating control of an external device and an electronic device supporting the same.

In accordance with an aspect of the present disclosure, an electronic device is provided. The electronic device includes a memory for storing device objects corresponding to a plurality of external devices and a processor operatively connected to the memory, wherein the processor outputs at least some of the device objects based on information related to control of the plurality of external devices, receives an input for selecting at least one device object from among the at least some of the device objects, and generates action group information by grouping pieces of action information for instructing external devices corresponding to the selected at least one device object to perform a specified operation.

In accordance with another aspect of the present disclosure, an external device operating method is provided. The external device operating method includes outputting at least some of device objects based on information related to control of a plurality of external devices, receiving an input for selecting at least one device object from among the at least some of the device objects, and generating action group information related to control of selected external devices by grouping pieces of action information for instructing external devices corresponding to the selected at least one device object to perform a specified operation.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an example of an integrated operation system related to operation of an electronic device according to an embodiment of the present disclosure;

FIG. 2 is a diagram illustrating an example of an integrated operation module according to an embodiment of the present disclosure;

FIG. 3 is a diagram illustrating an example of a management device according to an embodiment of the present disclosure;

FIG. 4 is a diagram illustrating a new action managing method in relation to an external device operating method according to an embodiment of the present disclosure;

FIG. 5 is a diagram illustrating a priority setting method in relation to an external device operating method according to an embodiment of the present disclosure;

FIG. 6 is a diagram illustrating execution of an action in relation to an electronic device operating method according to an embodiment of the present disclosure;

FIG. 7 is a diagram illustrating an example of a screen interface related to batch control during operation of an external device according to an embodiment of the present disclosure;

FIG. 8 is a diagram illustrating an example of a screen interface related to group control during operation of an external device according to an embodiment of the present disclosure;

FIG. 9 is a diagram illustrating an example of a screen interface related to priority setting during operation of an external device according to an embodiment of the present disclosure;

FIG. 10 is a system diagram illustrating an example of a signal flow related to execution of an action considering a conflict between actions during operation of an external device according to an embodiment of the present disclosure;

FIG. 11 is a system diagram illustrating another example of a signal flow related to execution of an action considering a conflict between actions during operation of an external device according to an embodiment of the present disclosure;

FIG. 12 is a block diagram illustrating an electronic device according to an embodiment of the present disclosure; and

FIG. 13 is a diagram illustrating a program block according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “have”, “may have”, “include”, “may include”, “comprise”, or the like used herein indicates the existence of a corresponding feature (e.g., a number, a function, an operation, or an element) and does not exclude the existence of an additional feature.

The term “A or B”, “at least one of A and/or B”, or “one or more of A and/or B” may include all possible combinations of items listed together. For example, the term “A or B”, “at least one of A and B”, or “at least one of A or B” may indicate all the cases of (1) including at least one A, (2) including at least one B, and (3) including at least one A and at least one B.

The term “first”, “second” or the like used herein may modify various elements regardless of the order and/or priority thereof, but does not limit the elements. For example, “a first user device” and “a second user device” may indicate different user devices regardless of the order or priority. For example, without departing the scope of the present disclosure, a first element may be referred to as a second element and vice versa.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) between the element and the other element.

The term “configured (or set) to” used herein may be interchangeably used with the term, for example, “suitable for”, “having the capacity to”, “designed to”, “adapted to”, “made to”, or “capable of”. The term “configured (or set) to” may not necessarily have the meaning of “specifically designed to”. In some cases, the term “device configured to” may indicate that the device “may perform” together with other devices or components. For example, the term “processor configured (or set) to perform A, B, and C” may represent a dedicated processor (e.g., an embedded processor) for performing a corresponding operation, or a generic-purpose processor (e.g., a central processing unit (CPU) or an application processor (AP)) for executing one software program stored in a memory device to perform a corresponding operation.

The terminology used herein is only used for describing specific embodiments and is not intended to limit the scope of other embodiments. The terms of a singular form may include plural forms unless otherwise specified. The terms used herein, including technical or scientific terms, have the same meanings as understood by those skilled in the art. Commonly-used terms defined in a dictionary may be interpreted as having meanings that are the same as or similar to contextual meanings defined in the related art, and should not be interpreted in an idealized or overly formal sense unless otherwise defined explicitly. Depending on cases, even the terms defined herein should not be such interpreted as to exclude various embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device (e.g., smartglasses, a head-mounted device (HMD), an electronic apparel, an electronic bracelet, an electronic necklace, an electronic appcessory, an electronic tattoo, a smart mirror, or a smartwatch).

Hereinafter, an electronic device according to various embodiments of the present disclosure will be described with reference to the accompanying drawings. The term “user” used herein may refer to a person who uses an electronic device or may refer to a device (e.g., an artificial electronic device) that uses an electronic device.

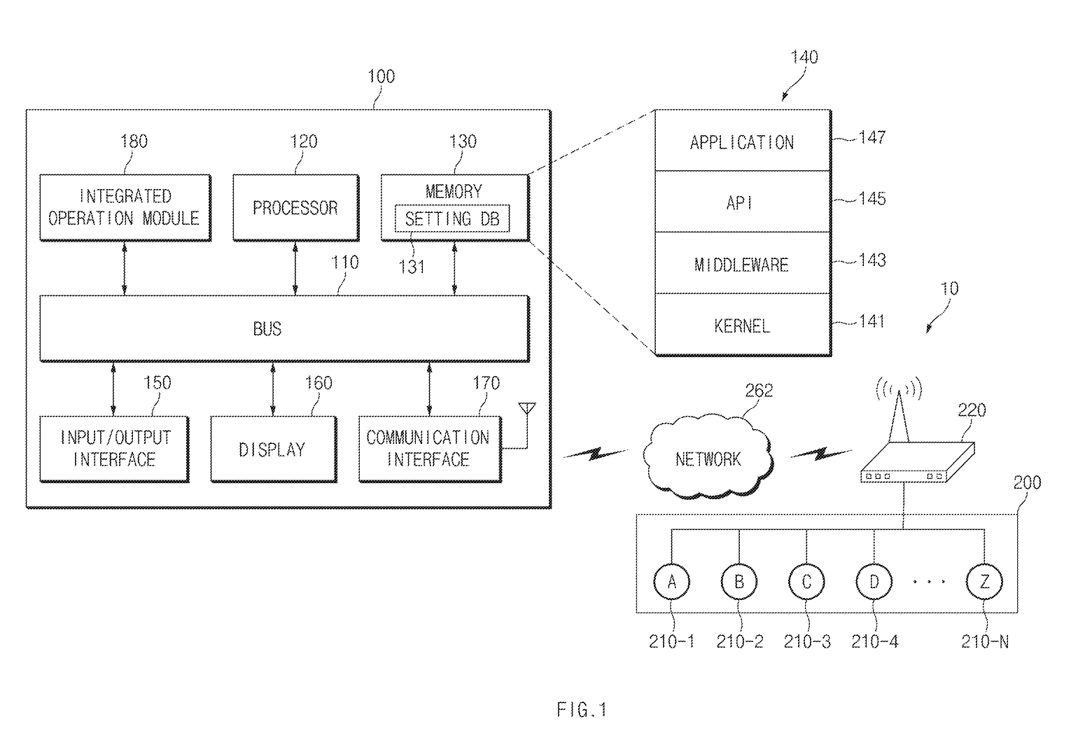

FIG. 1 is a diagram illustrating an example of an integrated operation system related to operation of an electronic device according to an embodiment of the present disclosure.

Referring to FIG. 1, an integrated operation system 10 may include an electronic device 100, a network 262, an external device 200, and a management device 220.

In the integrated operation system 10, the electronic device 100 may establish a communication channel to the management device 220 via the network 262. The management device 220 may be connected to the external device 200 wirelessly or by wire. The electronic device 100 may perform control of action group information generation, storage, or transmission related to operation of the external device 200, based on the management device 220. Action information may include a command for commanding execution of a specific operation of an external device. For example, the action information may include at least one control command related to turning on or off, level adjustment, etc. of a specific external device.

According to various embodiments of the present disclosure, the electronic device 100 may generate action group information by grouping a plurality of pieces of action information so that a plurality of external devices perform specific operations simultaneously or sequentially or according to a certain order. Accordingly, the action group information may correspond to a set of pieces of action information related to mutual operations of a plurality of external devices 210-1 to 210-N. The action group information may include a control command for defining an operation of the plurality of external devices 210-1 to 210-N at a certain time or an operation to be performed according to an operation state of other externals devices 210-1 to 210-N.

The action group information may include, for example, action group information for each scenario defined to operate the plurality of external devices 210-1 to 210-N according to a certain scenario, action group information for each location defined so that the plurality of external devices 210-1 to 210-N are operated in each group according to arrangement positions of the plurality of external devices 210-1 to 210-N, and action group information for each time defined so that the plurality of external devices 210-1 to 210-N perform a specified operation for each specified time.

According to an embodiment of the present disclosure, the electronic device 100 may provide a user interface for providing an action group object corresponding to the action group information and a user interface for combining or modifying pieces of the action group information. The electronic device 100 may provide at least one of a user interface for combining or modifying the action group information and a single piece of action information or a user interface for setting a priority of the action group information or a single piece of action information. The electronic device 100 may provide support so that action designing for each scenario or generation of new action group information related to control of the external device 200 may be performed more intuitively and easily through the above-mentioned user interfaces.

The network 262, for example, may support establishment of a wireless communication channel or a wired communication channel between the electronic device 100 and the management device 220. According to an embodiment of the present disclosure, the network 262 may establish a wireless communication channel to the electronic device 100. The network 262 may establish a wired communication channel to the management device 220. Alternatively, the network 262 may establish a wireless communication channel to the management device 220. The network 262 may include at least one device element capable of supporting a wireless communication function (e.g., various wireless communication standards such as second generation (2G), third generation (3G), fourth generation (4G), long term evolution (LTE), fifth generation (5G), etc.), a wireless access communication function (e.g., a Wi-Fi communication function), etc. The network 262 may include at least one of telecommunications networks, for example, a computer network (e.g., a local area network (LAN) or wide area network (WAN)), the Internet, or a telephone network. The network 262 may include a short-range communication network.

The management device 220 may include, for example, at least one of a hub or a server. The management device 220 may be connected to the external device 200. The management device 220 may handle a command related to control of an attribute (capability) of at least one external device 210-1 to 210-N included in the external device 200.

According to an embodiment of the present disclosure, the management device 220 may provide, to the electronic device 100, information related to the external devices 210-1 to 210-N connected to the management device 220. The management device 220 may receive, from the electronic device 100, action group information related to control of operation of at least a portion of the external devices 210-1 to 210-N. The management device 220 may control operation of at least a portion of the external devices 210-1 to 210-N according to the action group information received. In relation to this operation, the management device 220 may include a processor (e.g., a handler) for analyzing an attribute of the external device 200 and handling a command according to the attribute.

According to various embodiments of the present disclosure, the handler of the management device 220 may modify action information related to attribute analysis and command handling so that the action information is provided in the form of an interface specified in the electronic device 100, and may provide the modified information to the electronic device 100.

According to an embodiment of the present disclosure, the electronic device 100 may perform a function of the management device 220. The management device 100 may control operation of at least a portion of the external devices 210-1 to 210-N via the network 262 (e.g., short-range communications) without the additional management device 220.

The external device 200 may include at least one external device 210-1 to 210-N. The at least one external device 210-1 to 210-N, which are, for example, Internet of things (IoT) devices, may include at least one electronic device capable of establishing a communication channel to a peripheral device (e.g., the electronic device 100 or the management device 220). For example, the external devices 210-1 to 210-N may include various electronic devices such as a lighting device, a temperature regulator, a position sensor, a contact sensor, an alarm device, an information display device, a door device, etc. The at least one external devices 210-1 to 210-N, for example, may be grouped for each location. For example, the external devices 210-1 to 210-N may be arranged in plurality in a home, and may be grouped for each room of the home. Alternatively, even if the external devices 210-1 to 210-N are arranged in different locations, the external devices 210-1 to 210-N may be grouped together according to a specified scenario. The above-mentioned external devices 210-1 to 210-N may be connected to the management device 220, and may perform a specified operation based on a command corresponding to action group information provided by the management device 220.

According to various embodiments of the present disclosure, the external devices 210-1 to 210-N may be provided so as to interface with the management device 220 in relation to operation control according to an attribute. For example, the lighting device may have a power-on attribute, a power-off attribute, a brightness adjustment attribute, etc. The alarm device may have an alarm-on attribute, an alarm-off attribute, and an alarm loudness adjustment attribute. The temperature regulator may have a temperature sensing attribute, a temperature sensing stop attribute, and an attribute of outputting heated or cooled air according to a sensed temperature and a specified temperature. The information display device may have a device turn-on attribute, a device turn-off attribute, an attribute of adjusting a size or brightness of an output screen, etc. The door device may have a door opening attribute, a door closing attribute, a door lock setting attribute, etc. Each of the above-mentioned attribute may correspond to action information.

The electronic device 100 may include a bus 110, a processor 120, a memory 130, an input/output interface 150, a display 160, a communication interface 170, and an integrated operation module 180.

The bus 110 may include a circuit for connecting the above-mentioned elements 110 to 180 to each other and transferring communications (e.g., control messages and/or data) among the above-mentioned elements. For example, the bus 110 may connect the communication interface 170 to the integrated operation module 180. The bus 110 may support transfer of information required for generating new action group information and transfer of information for storing generated new action group information. The bus 110 may transfer specified action group information to the communication interface 170 in response to a user input.

The processor 120 may include at least one of a CPU, an AP, or a communication processor (CP). The processor 120 may perform data processing or an operation related to communication and/or control of at least one of the other elements of the electronic device 100.

According to an embodiment of the present disclosure, the processor 120 may handle activation of a smart application related to operation control of at least a portion of the plurality of external devices 210-1 to 210-N connected to the management device 220 in response to a user input. The processor 120 may handle output of a screen related to an activated smart application. The processor 120 may handle transfer of specified action group information based on a smart application. The processor 120 may handle generation of new action group information based on a smart application in response to a user input. For example, the processor 120 may handle generation of action group information for each scenario, action group information for each location, or action group information for each time in response to a user input. The processor 120 may handle generation of new action group information according to a combination of action group information and a single piece of action information. The processor 120 may handle modification of generated action group information in response to a user input. The processor 120 may handle setting of a priority of action group information in response to a user input. The processor 120 may handle output of a device object corresponding to action information and an action group object corresponding to action group information. In relation to the above-mentioned handling, the processor 120 may include at least a part of the integrated operation module 180, or at least one processor 120 may constitute at least a part of the integrated operation module 180.

The memory 130 may include a volatile memory and/or a nonvolatile memory. The memory 130 may store instructions or data related to at least one of the other elements of the electronic device 100. The instructions may be executed by at least one of the processor 120 or the integrated operation module 180.

According to an embodiment of the present disclosure, the instructions may include an instruction set related to execution of a smart application and an instruction set configured to transmit specified action group information to the management device 220 according to a specified condition (e.g., a user input, arrival of a specified schedule, or the like). The instructions may include an instruction set related to generation of new action group information, an instruction set related to modification of generated action group information, and an instruction set related to determination of a priority of action group information.

According to various embodiments of the present disclosure, the memory 130 may store a setting database 131. The setting database 131 may include, for example, at least one piece of action group information related to control of the plurality of external devices 210-1 to 210-N. The action group information may include a plurality of pieces of action information related to operation control of a plurality of specified external devices. The setting database 131 may include priority information of pieces of action information or action group information. The priority information may represent information for defining an order of priority of execution of pieces of action information or action group information. For example, an operation state of the external device 200 corresponding to action group information with a relatively high priority may be preferentially handled over an operation state of the external device 200 corresponding to action group information with a relatively low priority. According to various embodiments of the present disclosure, the setting database 131 may include an action group object corresponding to action group information and a device object related to action information of at least one external device 210-1 to 210-N.

According to various embodiments of the present disclosure, the memory 130 may store software and/or a program 140. The program 140 may include, for example, a kernel 141, a middleware 143, an application programming interface (API) 145, and/or an application program (or an application) 147. At least a portion of the kernel 141, the middleware 143, or the API 145 may be referred to as an operating system (OS).

The kernel 141 may control or manage system resources (e.g., the bus 110, the processor 120, the integrated operation module 180, or the memory 130) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 100 in order to control or manage the system resources.

The middleware 143 may serve as an intermediary so that the API 145 or the application program 147 communicates and exchanges data with the kernel 141. Furthermore, the middleware 143 may handle one or more task requests received from the application program 147 according to a priority order. For example, the middleware 143 may assign at least one application program 147 a priority for using the system resources (e.g., the bus 110, the processor 120, the integrated operation module 180, the memory 180, or the like) of the electronic device 100. For example, the middleware 143 may handle the one or more task requests according to the priority assigned to the at least one application program 147, thereby performing scheduling or load balancing with respect to the one or more task requests.

The API 145 may include an interface for allowing the application 147 to control functions provided from the kernel 141 or the middleware 143. The API 145 may include, for example, at least one interface or function (e.g., an instruction) for the purpose of file control, window control, image processing, character control, or the like.

The application 147 may include at least one application. For example, the application 147 may include a music application, an exercise (or healthcare) application, an alarm application, etc. According to an embodiment of the present disclosure, the application 147 may include a smart application related to operation control or operation setting of the plurality of external devices 210-1 to 210-N. The smart application may be executed in response to a user input or arrival of a specified schedule. As the smart application is executed, the electronic device 100 may provide at least one user interface related to control of the external devices 210-1 to 210-N.

According to an embodiment of the present disclosure, the smart application may provide execution-requested action group information in response to a user input or a set schedule. The smart application may provide a function of generating new action group information, modifying action group information, or setting a priority of action group information.

The input/output interface 150 may serve to transfer an instruction or data input from a user or another external device to (an)other element(s) of the electronic device 100. Furthermore, the input/output interface 150 may output instructions or data received from (an)other element(s) of the electronic device 100 to the user or another external device. The input/output interface 150 may include, for example, at least one physical button or touch button or a touchpad or a touch screen. Furthermore, the input/output interface 150 may include a means for input by an electronic pen or the like. Moreover, the input/output interface 150 may include an audio device for processing audio signals. The audio device may output audio data related to execution of the smart application. This audio data output function may not be performed according to a setting or a user input.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, or the like) to the user. The display 160 may include a touch screen, and may receive a touch, gesture, proximity or hovering input from an electronic pen or a part of a body of the user.

The display 160 may output at least one screen related to execution of a smart application of the electronic device 100. For example, the display 160 may output at least one action group object stored. If a specific action group object is selected or an action group object is selected as a specified condition is satisfied, the electronic device 100 may transmit, to the management device 220, action group information corresponding to a selected action group object. The action group information may include information for defining an action of each of the plurality of external devices 210-1 to 210-N. The display 160 may output a screen interface related to generation of a new action or modification of an action. The display 160 may output a screen interface for determining a priority of action group information.

The communication interface 170, for example, may set communications between the electronic device 100 and the management device 220. For example, the communication interface 170 may be connected to the network 262 via wireless communications so as to communicate with a management device (e.g., the management device 220 or a server 106). According to an embodiment of the present disclosure, the communication interface 170 may receive, from the management device 220, information on the external device 200. The communication interface 170 may provide, to the management device 220, action group information for controlling operation of at least one external device.

The wireless communications may employ at least one of cellular communication protocols such as LTE, LTE-advance (LTE-A), code division multiple access (CDMA), wideband CDMA (WCDMA), universal mobile telecommunications system (UMTS), wireless broadband (WiBro), or global system for mobile communications (GSM). Furthermore, the wireless communications may include, for example, short-range communications. The short-range communications may include at least one of wireless fidelity (Wi-Fi), Bluetooth, near field communication (NFC), magnetic stripe transmission (MST), global navigation satellite system (GNSS), or the like.

The GNSS may include, for example, at least one of global positioning system (GPS), global navigation satellite system (GLONASS), BeiDou navigation satellite system (hereinafter referred to as “BeiDou”), or Galileo, the European global satellite-based navigation system. Hereinafter, the term “GPS” and the term “GNSS” may be interchangeably used. A wired communication interface may include at least one of universal serial bus (USB), high definition multimedia interface (HDMI), recommended standard 232 (RS-232), plain old telephone service (POTS), or the like.

The integrated operation module 180 may represent a module for handling operation control of at least a portion of the external devices 210-1 to 210-N included in the external device 200. For example, the integrated operation module 180 may handle transmission of action group information related to operation control of at least a portion of the external devices 210-1 to 210-N. The integrated operation module 180 may handle generation of a new action and modification of an action previously generated and stored. The integrated operation module 180 may handle setting of priorities of pieces of action group information. In relation to this operation, the integrated operation module 180 may handle activation or operation of a smart application and provision of a screen interface. The integrated operation module 180 may be provided so as to include at least one processor 120 or may operate as a part of the processor 120. According to an embodiment of the present disclosure, the integrated operation module 180 may be provided in the form of software and may be uploaded to a processor so as to handle a function related to operation control of the external device 200.

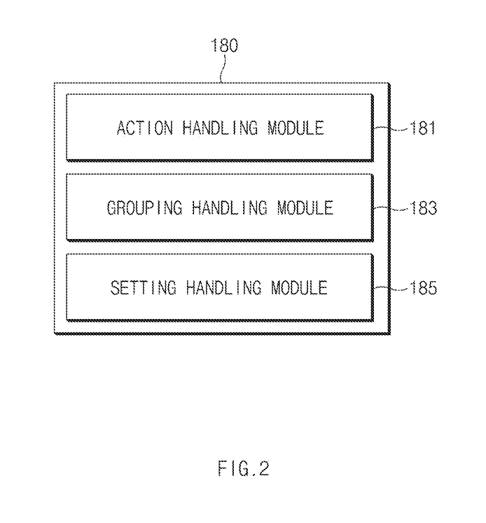

FIG. 2 is a diagram illustrating an example of an integrated operation module according to an embodiment of the present disclosure.

Referring to FIG. 2, the integrated operation module 180 according to an embodiment of the present disclosure may include an action handling module 181, a grouping handling module 183, and a setting handling module 185.

The action handling module 181 may handle operation control of at least a portion of the external devices 210-1 to 210-N included in the external device 200. For example, the action handling module 181 may activate a smart application in response to a user input, and may output at least one action group object. The action group object, for example, may be an item displayed according to pieces of action group information for controlling operation of the plurality of external devices 210-1 to 210-N. If one of action group objects is selected, the action handling module 181 may transmit, to the management device 220, action group information corresponding to the selected action group object via the communication interface 170.

According to various embodiments of the present disclosure, the action handling module 181 may transmit specified action group information to the management device 220 if a specified condition is satisfied (e.g., a schedule of a specified time arrives or the electronic device 100 is disposed on a specified location). According to various embodiments of the present disclosure, as the specified condition is satisfied, the action handling module 181 may output a popup window for querying whether to transmit the specified action group information to the management device 220. The action handling module 181 may determine whether to transmit the action group information according to a user input related to the popup window.

According to various embodiments of the present disclosure, in relation to transmission of action group information, the action handling module 181 may receive, from the management device 220, a message for notifying that previous action group information is being executed and may output the message. The action handling module 181 may perform control so that controlling the external device 200 according to the previous action group information is ended and the external device 200 is controlled according to new action group information, based on information received according to a specified policy or a specified condition. Alternatively, the action handling module 181 may transfer, to the setting handling module 185, guide information related to control of the external device 200 according to the previous action group information.

The grouping handling module 183 may handle action information grouping of the electronic device 100. In relation to this operation, if a user input occurs, the grouping handling module 183 may activate a smart application, and may output a user interface for action information grouping. According to an embodiment of the present disclosure, the grouping handling module 183 may output a device object related to operation control of the plurality of external devices 210-1 to 210-N. The grouping handling module 183 may handle setting of action information of at least one device object in response to a user input. If action information related to the plurality of external devices 210-1 to 210-N is set, the grouping handling module 183 may generate and store action group information by collecting each piece of action information. If retrieval of action group information is requested, the grouping handling module 183 may output, to the display 160, an action group object corresponding to the action group information. If a specific action group object is selected, the grouping handling module 183 may transfer, to the action handling module 181, action group information about the action group object.

According to various embodiments of the present disclosure, the grouping handling module 183 may support addition of at least one piece of action information to action group information. The action information, for example, may include information for controlling operation of one external device. In relation to this configuration, the grouping handling module 183 may output at least one device object related to operation control of external devices in response to a user input. If at least one device object and a specific action group object are selected, the grouping handling module 183 may generate integrated action information including selected action information and action group information.

According to various embodiments of the present disclosure, the grouping handling module 183 may support modification of action group information. For example, if an input event related to modification of specific action group information occurs, the grouping handling module 183 may display device objects that belong to the specific action group information. If a setting input for a specific device object occurs due to a user input, the grouping handling module 183 may modify action information about the device object, and then may update action group information. The grouping handling module 183 may delete action information of at least one device object belonging to a specific action group in response to a user input. According to various embodiments of the present disclosure, the grouping handling module 183 may display at least one action group object, and may generate integrated action group information by combining action group information specified in response to a user input and other action group information.

In relation to the above-mentioned generation and provision of action group information, the grouping handling module 183 may collect information on the external devices 210-1 to 210-N from the management device 220. For example, the grouping handling module 183 may collect attribute (capability) and command information of the external devices 210-1 to 210-N, and may group and provide devices having the same attribute based on the attribute and command information. When the grouped devices having the same attribute are provided, the devices may be provided differentially according to an arrangement location of each device. For example, the grouping handling module 183 may provide a plurality of lighting devices arranged in a certain space (e.g., a home, an office, a gymnasium, or the like) as one lighting device group. The grouping handling module 183 may differentially display lighting device sub groups based on a certain space (e.g., a room, a lake, a zone, or the like) with respect to a lighting device group including a plurality of lighting devices.

According to various embodiments of the present disclosure, the grouping handling module 183 may provide action information and action group information related to operation control of the plurality of external devices 210-1 to 210-N according to a user scenario setting. For example, the grouping handling module 183 may provide information on all IoT devices arranged in a certain area (e.g., a home, an office, or the like), and may handle a title (e.g., leaving work, going to work, cooking, or sleeping as a scenario title) input by the user and settings of external devices set thereby as action group information for each scenario. According to various embodiments of the present disclosure, the grouping handling module 183 may differentially provide action group information for each location with respect to IoT devices for each zone arranged in a certain area. The grouping handling module 183 may generate action group information for each time with respect to IoT devices frequency used for each time, and may provide an action group object corresponding to the action group information for each time.

The setting handling module 185 may handle setting of a priority. According to an embodiment of the present disclosure, if an input event related to priority setting occurs, the setting handling module 185 may provide a screen for changing a priority of at least one piece of action group information. The setting handling module 185 may adjust priorities of specific pieces of action group information in response to a user input. When an input for entering a specific priority value for specific action group information occurs, if there exists other action group information having the specific priority value, the setting handling module 185 may output an alarm notifying this fact. Alternatively, the setting handling module 185 may output guide information notifying that a priority of action group information having a previous priority value has been changed.

Upon receiving, from the action handling module 181, guide information related to control of the external device 200 according to previous action group information, the setting handling module 185 may output a popup window related to the external device 200. For example, the setting handling module 185 may output a popup window indicating that control of the external device 200 based on the previous action group information is ended, and the external device 200 is controlled according to new action group information. The setting handling module 185 may transmit, to the management device 220, a message for controlling the external device 200 according to the new action group information, in response to a user input.

According to the above-mentioned embodiments, an electronic device according to an embodiment of the present disclosure includes a memory for storing at least one instruction and a processor connected to the memory, wherein the instruction executed by the processor causes the processor to output device objects corresponding to a plurality of external devices based on information related to control of the plurality of external devices and generate, when an input event for selecting a plurality of device objects is received, action group information by grouping pieces of action information related to an operation setting of each of selected device objects.

According to the above-mentioned embodiments, an electronic device according to an embodiment of the present disclosure includes a memory for storing device objects corresponding to a plurality of external devices and a processor operatively connected to the memory, wherein the processor outputs at least some of the device objects based on information related to control of the plurality of external devices, receives an input for selecting at least one device object from among the at least some of the device objects, and generates action group information related to control of selected external devices by grouping pieces of action information for instructing external devices corresponding to the selected at least one device object to perform a specified operation.

According to various embodiments of the present disclosure, the instruction executed by the processor causes the processor to output an action group object corresponding to the action group information.

According to various embodiments of the present disclosure, the instruction executed by the processor causes the processor to generate, when at least one device object not included in the action group information is selected, integrated action information by combining action information related to the selected at least one device object with the action group information.

According to various embodiments of the present disclosure, the instruction executed by the processor causes the processor to output, when the action group object is selected, device objects respectively corresponding to a plurality of external devices related to the action group object.

According to various embodiments of the present disclosure, the action group information is updated according to a change in an operation setting of the device objects related to the action group object.

According to various embodiments of the present disclosure, the processor outputs at least one other action group information in response to an input event.

According to various embodiments of the present disclosure, when another action group object corresponding to the other action group information is selected, integrated action group information is generated by combining the other action group information with the action group information.

According to various embodiments of the present disclosure, the processor determines priorities of the action group information and the other action group information in response to an input event.

According to various embodiments of the present disclosure, the processor determines priorities of the device objects in response to an input event.

According to various embodiments of the present disclosure, the processor determines a priority of the action group information in response to an input event.

According to the above-mentioned embodiments, an electronic device according to an embodiment of the present disclosure includes a memory for storing at least one instruction and a processor connected to the memory, wherein the processor outputs a first action group object corresponding to at least one action group information obtained by grouping pieces of action information related to an operation setting of at least some of a plurality of external devices based on information related to control of the plurality of external devices.

According to various embodiments of the present disclosure, the processor outputs at least one second action group object corresponding to action group information including action information or external devices different from the above-mentioned action group information and at least one device object not included in the first action group object.

According to various embodiments of the present disclosure, the processor outputs, when the action group object is selected, device objects corresponding to a plurality of external devices related to the action group object.

According to various embodiments of the present disclosure, the processor outputs, when the device object is selected, a setting object for indicating or changing an action information state of the device object.

According to the above-mentioned embodiments, an electronic device according to an embodiment of the present disclosure includes a memory for storing at least one instruction and a processor connected to the memory, wherein the processor outputs a priority change area of a first action group object corresponding to at least one action group information obtained by grouping pieces of action information related to an operation setting of at least some of a plurality of external devices based on information related to control of the plurality of external devices.

According to various embodiments of the present disclosure, the processor changes a priority of the first action group object in response to an input event.

According to the above-mentioned embodiments, an electronic device according to an embodiment of the present disclosure includes a memory for storing at least one instruction and a processor connected to the memory, wherein the processor transmits, to a plurality of external devices if a specified condition is satisfied, at least one action group information obtained by grouping pieces of action information related to an operation setting of at least some of the plurality of external devices based on information related to control of the plurality of external devices.

According to various embodiments of the present disclosure, the processor transmits priority information of the action group information to the external devices.

According to various embodiments of the present disclosure, the processor transmits the action group information to a management device connected to the external devices.

According to the above-mentioned embodiments, an electronic device according to an embodiment of the present disclosure includes a memory for storing at least one instruction and a processor connected to the memory, wherein the processor outputs a plurality of action group objects corresponding to pieces of action group information obtained by grouping pieces of action information related to an operation setting of at least some of a plurality of external devices based on information related to control of the plurality of external devices.

According to various embodiments of the present disclosure, the processor generates integrated action group information by combining a plurality of action group objects in response to an input event.

According to various embodiments of the present disclosure, the processor transmits the integrated action group information to a management device connected to the external devices if a specified condition is satisfied.

According to various embodiments of the present disclosure, the processor outputs information for determining execution of one of different pieces of action information for the same external device included in the integrated action group information.

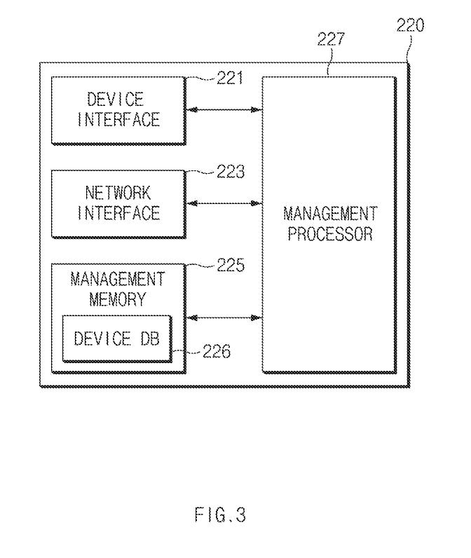

FIG. 3 is a diagram illustrating an example of a management device according to an embodiment of the present disclosure.

Referring to FIG. 3, the management device 220 may include a device interface 221, a network interface 223, a management memory 225, and a management processor 227.

The device interface 221 may include at least one communication module connectable to the external device 200. For example, the device interface 221 may include a wired communication module for communicating with a lighting device, a wired/wireless communication module for communicating with at least one sensor, a wired/wireless communication module for communicating with a camera, etc. The device interface 221 may receive device IDs and event IDs of connected external devices 200 and attribute information related to operation control thereof, and may provide the received IDs and information to the management processor 227.

The network interface 223 may establish a communication channel to the electronic device 100 via the network 262. The network interface 223, for example, may receive action group information from the electronic device 100. Alternatively, the network interface 223 may receive integrated action information and integrated action group information from the electronic device 100. The network interface 223 may provide received information to the management processor 227. The network interface 223 may transfer, to the electronic device 100, information on event IDs and device IDs of the plurality of external devices 210-1 to 210-N included in the external device 200.

The management memory 225 may store a device database 226. The device database 226 may include information on the connected external device 200 (e.g., IDs and attribute information of the external devices 210-1 to 210-N and command information to be provided according to attributes thereof). The device database 226 may store information on current states of the external devices 210-1 to 210-N. The device database 226 may store information indicating action group information on which current operation of the external devices 210-1 to 210-N is based. The device database 226 may store priority information of action group information that is currently being executed.

The management processor 227 may control the device interface 221. For example, the management processor 227 may determine connection states of the external devices 210-1 to 210-N at a certain period or in response to occurrence of an initialization event or specified input event. After determining the connection states, the management processor 227 may collect the types, device IDs, and attribute information of currently connected external devices 210-1 to 210-N and arrangement location information of the external devices 210-1 to 210-N. Based on this information, the management processor 227 may update the device database 226. According to various embodiments of the present disclosure, the management processor 227 may update the device database 226 when a new external device is connected or a connected external device is disconnected.

The management processor 227 may control the network interface 223. For example, the management processor 227 may provide type information and attribute information of the external devices 210-1 to 210-N stored in the device database 226 in response to a request from the electronic device 100. The electronic device 100 may generate a device object based on the type information of the external devices 210-1 to 210-N, and may handle setting of action information corresponding to the device object based on the attribute information. Upon receiving action group information from the electronic device 100, the management processor 227 may control operation of the external devices 210-1 to 210-N corresponding to the action group information.

According to various embodiments of the present disclosure, the management processor 227 may compare priority information of previous action group information which has been already applied with priority information of newly received action group information. The management processor 227 may provide a result of priority information comparison to the electronic device 100. According to various embodiments of the present disclosure, if the priority information of the new action group information is higher, the management processor 227 may control operation of the external devices 210-1 to 210-N based on the new action group information. If the priority information of the previous action group information is higher, the management processor 227 may wait for an end of the previous action group information, and then may handle action control of the external devices 210-1 to 210-N corresponding to the new action group information.

According to various embodiments of the present disclosure, the management processor 227 may store and mange a history of operation states of the external devices. The management processor 227 may generate a record of use of the external devices for each time based on the history, and may group the external devices based on a certain time range. The management processor 227 may provide, to the electronic device 100, group information according to the record of use of the external devices in response to a request from the electronic device 100.

According to the above-mentioned embodiments, a management device according to an embodiment of the present disclosure includes a management memory for storing instructions related to control of external devices and a management processor connected to the management memory, wherein, if action group information obtained by grouping operation settings of a plurality of external devices is received from an electronic device, the management processor controls operation of the external devices according to the action group information.

In case when different pieces of action information for the same external device are included in the action group information, the management processor determines priorities of the different pieces of action information, and executes action information having a higher priority.

In case when different pieces of action information for the same external device are included in the action group information, the management processor sends a request for selection of information to be executed to the electronic device that has transmitted the action group information.

According to the above-mentioned embodiments, an electronic device according to an embodiment of the present disclosure includes a memory for storing information corresponding to a device group including at least one external device and configured to perform a first function and a processor operatively connected to the memory, wherein the processor may be configured to receive a request for performing a second function by the at least one external device, select at least one of the first function or the second function based on at least the information corresponding to the device group in response to the request received, and transmit a command for performing the at least one of the first function or the second function to the at least one external device.

The device group may be generated using at least one external device. For example, the device group may be a set of external devices obtained by grouping external devices related to IoT so that the external devices operate in a specified mode or scene. According to an embodiment of the present disclosure, while action group information related to a movie view mode or scene or function is defined, the device group may include a set of respective devices (e.g., a television (TV), a speaker, a cleaner, a lamp, etc.) for performing corresponding action group information. Another device group including the at least one external device may include the case in which the types of external devices are different from each other, or the same external device is included but there are different pieces of action information to be performed.

According to various embodiments of the present disclosure, in order to execute the movie view function or mode, action group information defined so that first to third external devices corresponding to a first device group perform first to third functions may be stored. According to various embodiments of the present disclosure, in order to execute a leaving work function or a leaving work mode, action group information defined so that third to fifth external devices corresponding to a second device group (a device group different from the first device group) perform fourth to sixth functions may be stored. Here, if a new function is generated by a combination of the movie view function and the leaving work function or a request for execution of the leaving work function is made while the movie view function is executed, the electronic device may determine whether to perform the third function or the fourth function of the third external device which is included in duplicate based on information (e.g., a priority of the movie view function and a priority of the leaving work function) corresponding to each device group.

According to various embodiments of the present disclosure, the processor may be configured so that the request is received in association with another device group including at least one external device.

According to various embodiments of the present disclosure, the second function may include a function to be executed in association with the other device group including the at least one external device.

According to various embodiments of the present disclosure, the processor may be configured to select the at least one function further based on either one of the device group and the other device group having a higher priority.

According to various embodiments of the present disclosure, the processor may be configured to select the at least one function further based on a level of contribution (relevance or importance) of the first function relative to (entire) group capability (action) to be performed by the device group and a level of contribution of the second function relative to (entire) other group capability (action) to be performed by the other device group.

The level of contribution, for example, may be determined by priorities of device groups. Alternatively, the level of contribution may be determined by respective priorities of external devices belonging to the device groups. Alternatively, the level of contribution may be determined by a priority of a function (or action) set to be performed by the external devices belonging to the device groups. Furthermore, the level of contribution may be determined based on a sum of priorities of a plurality of external devices forming a device group.

According to various embodiments of the present disclosure, the processor may be configured to select the at least one function further based on a priority or contents corresponding to the first function and a priority or contents corresponding to the second function.

According to various embodiments of the present disclosure, the processor may be configured to select the at least one function further based on a time at which the request is received.

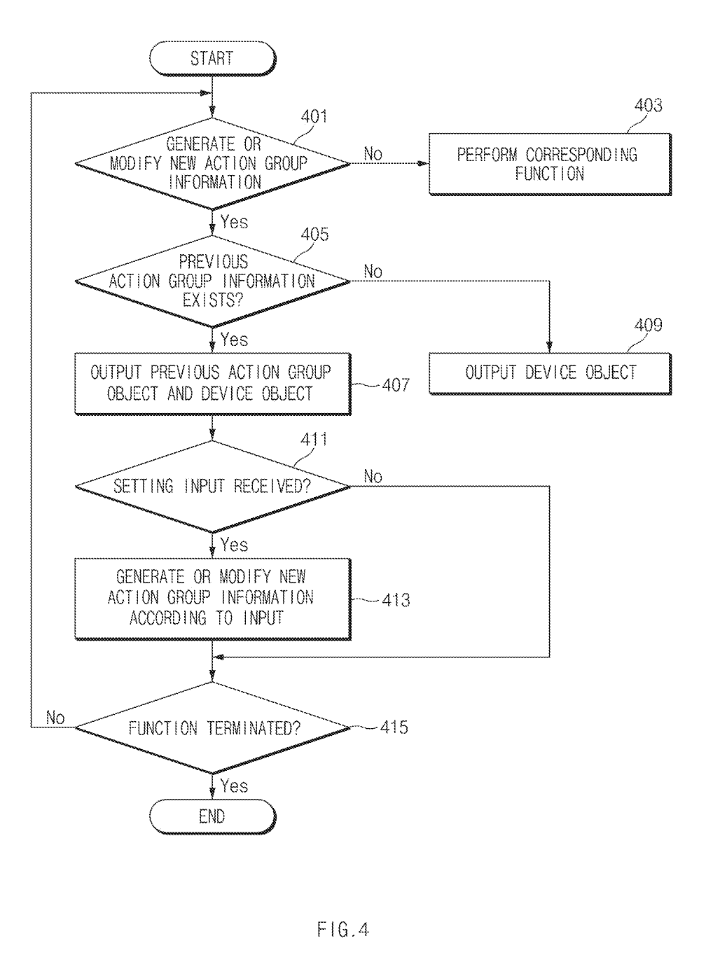

FIG. 4 is a diagram illustrating a new action managing method in relation to an external device operating method according to an embodiment of the present disclosure.

Referring to FIG. 4, in operation 401, the electronic device 100 may determine whether an event for requesting generation or modification of new action group information occurs. In relation to this operation, the electronic device 100 may provide an icon or a menu related to execution of a smart application. If a smart application is executed, the electronic device 100 may determine whether an event related to selection of a new action group information generation or modification item occurs. If there is no event related to generation or modification of new action group information, the electronic device 100 may support execution of a function corresponding to the type of an event that has occurred in operation 403. For example, the electronic device 100 may transmit action group information to the management device 220 in response to a user input.

If an event related to generation or modification of new action group information occurs, the electronic device 100 may determine whether previous action group information exists in operation 405. If the previous action group information exists, the electronic device 100 may output a previous action group object or may output, to the display 160, the previous action group object and a device object in operation 407. The previous action group object, for example, may represent an object output to the display 160 according to action group information obtained by grouping at least one piece of action information related to operation control of at least one external device. The device object may represent an object output to the display 160 according to action information corresponding to a specific external device.

If the previous action group information does not exist, the electronic device 100 may output, to the display 160, a device object corresponding to at least one external device in operation 409. For example, the electronic device 100 may output, to a specified area of the display 160, device objects for controlling operation of each external device. In relation to this operation, the electronic device 100 may receive, from the management device 220, device information corresponding to the external devices 210-1 to 210-N, and may output device objects respectively corresponding to pieces of the device information. The electronic device 100 may receive, from the management device 220, attribute information related to operation control of the external devices 210-1 to 210-N. The electronic device 100 may provide a function related to operation setting of the external devices 210-1 to 210-N based on the attribute information.

In operation 411, the electronic device 100 may determine whether a setting input is received. If there is no setting input, the electronic device 100 may skip operation 413. If the setting input is received, the electronic device 100 may perform generation or modification of new action group information according to the input in operation 413.

According to an embodiment of the present disclosure, in relation to generation of new action group information, the electronic device 100 may output a plurality of device objects to a specified area of the display 160. The electronic device 100 may output guide information related to operation setting when a device object is selected. If operation setting of selected device objects is completed, the electronic device 100 may generate new action group information by grouping pieces of action information of the selected device objects. In this operation, the electronic device 100 may support setting of a name of the new action group information. When outputting the device objects, the electronic device 100 may group the device objects for each area in which external devices are arranged. Alternatively, the electronic device 100 may group the device objects corresponding to external devices according to use thereof for each time to output the device objects. Alternatively, the electronic device 100 may output all device objects corresponding to external devices.

According to various embodiments of the present disclosure, the electronic device 100 may output, to a specified area, device objects corresponding to previous action group information. When a specific device object is selected, the electronic device 100 may output a change window for changing an operation setting of the device object. When a setting input occurs, the electronic device 100 may change the operation setting of the specific device object in response to the input, and may update action information corresponding thereto.

According to various embodiments of the present disclosure, in relation to modification of action group information, the electronic device 100 may output device objects corresponding to previous action group information. The electronic device 100 may receive an input for deleting at least one of the device objects corresponding to the previous action group information. The electronic device 100 may delete, from the previous action group information, action information corresponding to a device object selected by the input.

According to various embodiments of the present disclosure, in relation to modification of action group information, the electronic device 100 may output, to a first area, device objects corresponding to previous action group information and may output, to a second area, device objects not related to the previous action group information. If a device object is selected in the second area, the electronic device 100 may request operation setting for the selected device object. If the operation setting for the device object is completed, the electronic device 100 may add, to the previous action group information, action information corresponding to the device object.

In operation 415, the electronic device 100 may determine whether an event related to function termination occurs. If the event related to function termination does not occur, the process may return to operation 401, 407, or 409 according to the type of an event that has occurred. If the event related to function termination occurs, the electronic device 100 may end a function of generating or modifying new action group information, and may return to a previous function screen (e.g., a standby screen, a screen of a function executed immediately before performing the function of generating or modifying new action group information, etc.).

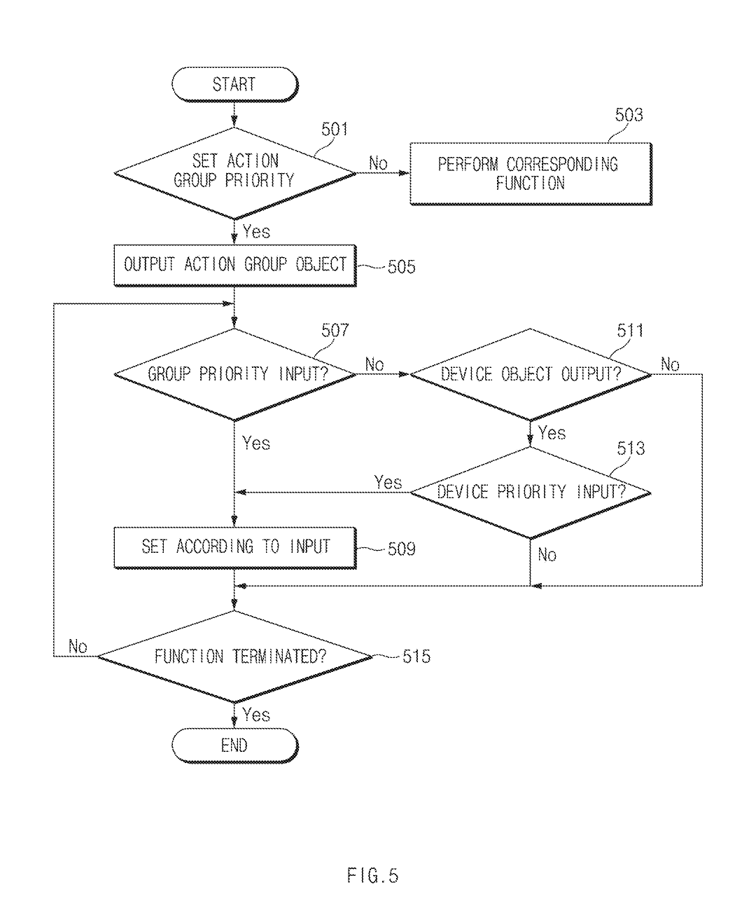

FIG. 5 is a diagram illustrating a priority setting method in relation to an external device operating method according to an embodiment of the present disclosure.

Referring to FIG. 5, in operation 501, the electronic device 100 may determine whether an event related to setting of a priority of an action group occurs. If there is no event related to setting of a priority of an action group, the electronic device 100 may handle execution of a function corresponding to the type of an event that has occurred in operation 503. For example, the electronic device 100 may transmit, to the external device 200, action group information corresponding to an action group selected from among action groups. The electronic device 100 may generate new action group information or modify previous action group information in response to a user input.

If the event related to setting of a priority of an action group occurs, the electronic device 100 may output an action group object in operation 505. The action group object, for example, may represent an object corresponding to information obtained by grouping pieces of action information related to operation control of a plurality of external devices. According to an embodiment of the present disclosure, the action group object may include, for example, title information of action group information, priority information of action group information, etc. Furthermore, the action group object may include an area for changing priority information.

If an event occurs in operation 507, the electronic device 100 may determine whether the event is an input related to a group priority. For example, the electronic device 100 may determine whether an input event for selecting a specific action group object related to a change of a priority occurs. In case when the event is an input related to a group priority, the electronic device 100 may handle setting according to the input in operation 509. For example, the electronic device 100 may determine a priority of action group information of at least one of action group objects according to the event that has occurred. According to an embodiment of the present disclosure, the electronic device 100 may provide a function of entering priority information of action group objects. Alternatively, the electronic device 100 may provide a function of determining a priority of action group information according to an order in which action group objects are arranged.

If the input is not related to a priority, the electronic device 100 may determine whether the input is intended to output a device object in operation 511. If the input is not for requesting output of a device object, the process may proceed to operation 515. If an event that has occurred is the input for requesting output of a device object, the electronic device 100 may output at least one device object to the display 160. If an event occurs, the electronic device 100 may determine whether the event is an input related to a device priority in operation 513. If an input related to a priority of a device object occurs, the process may proceed to operation 509 so that setting may be handled according to the input. For example, the electronic device 100 may determine a priority based on an order in which device objects are arranged or sequence information assigned to device objects. In relation to this operation, the electronic device 100 may provide a screen interface for determining a priority of a device object.

If the input related to a device priority does not occur in operation 513, the process may proceed to operation 515. In operation 515, the electronic device 100 may determine whether an event related to function termination occurs. If the event related to function termination does not occur, the process may proceed to operation 507. Alternatively, according to the type of an event that has occurred, the process may proceed to operation 505, 507, or 511 so that the electronic device 100 may handle a function according to a corresponding operation.

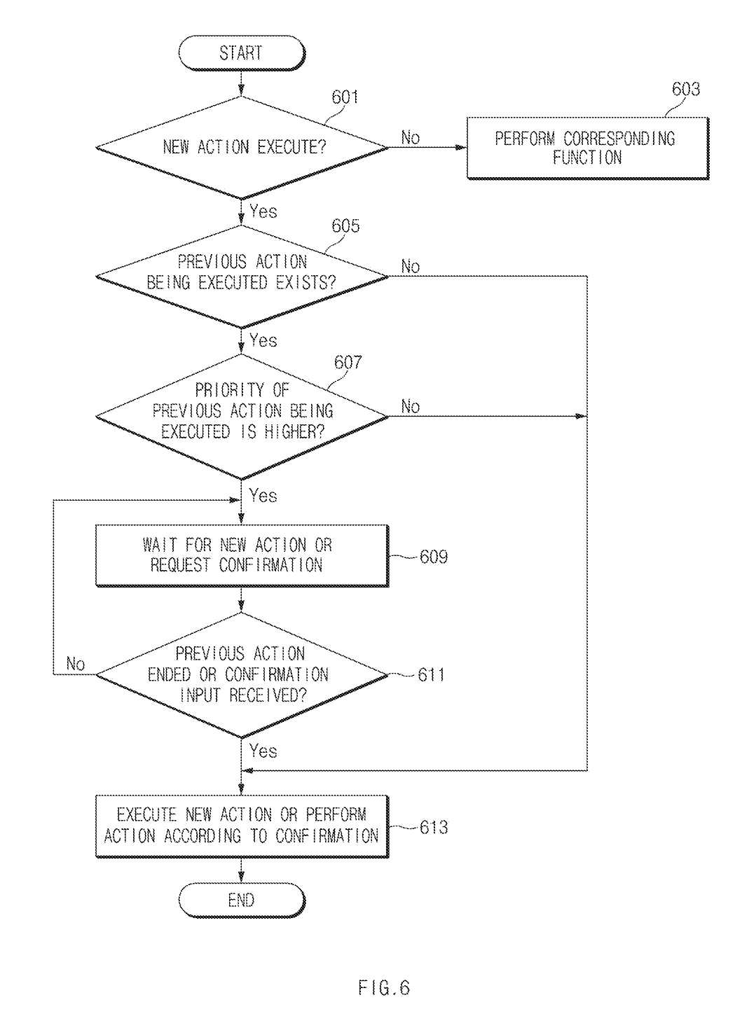

FIG. 6 is a diagram illustrating execution of an action in relation to an electronic device operating method according to an embodiment of the present disclosure.

Referring to FIG. 6, in operation 601, the electronic device 100 may determine whether an input event related to execution of a new action occurs. For example, the electronic device 100 may determine whether a specified condition related to transmission of new action group information is satisfied. The specified condition may include, for example, reception of an input signal for selecting an action group object corresponding to action group information, occurrence of a request for transmission of specified action group information in response to arrival of a specified schedule, and disposition of the electronic device 100 at a specified location.

If an event that has occurred is not related to execution of a new action, the electronic device 100 may handle execution of a function according to the type of the event in operation 603. For example, the electronic device 100 may handle generation of new action group information or modification of previous action group information in response to a user input. Alternatively, the processor 100 may set a priority of action group information in response to a user input.

If an event related to execution of a new action occurs, the electronic device 100 may determine whether there exists a previous action that is currently being executed in operation 605. For example, the electronic device 100 may inquire of the management device 220 whether there is action group information currently being applied. Alternatively, the electronic device 100 may determine whether previous action group information transmitted to the management device 220 is valid. In relation to determination of validity, the electronic device 100 may determine validity of conditions (e.g., a state in which the electronic device 100 is disposed at a specified location, not exceeding a specified time, etc.) defined in the previous action group information. If there is no previous action currently being executed, the electronic device 100 may skip following operations (e.g., operation 607, operation 609, operation 611, etc.).

If there exists a previous action currently being executed, the electronic device 100 may determine whether a priority of the previous action currently being executed is higher than a priority of a new action requested to be executed, in operation 607. In this operation, the electronic device 100 may extract priority information of previous action group information related to the previous action and priority information of new action group information, and may compare the extracted priority information. If the priority of the new action is higher, the electronic device 100 may skip following operations (e.g., operation 609, operation 611, etc.).

If the priority of the new action is lower, the electronic device 100 may wait for a new action or make a request for confirmation. For example, in relation to waiting for a new action, the electronic device 100 may determine whether control of the external device 200 according to previous action group information is ended. According to various embodiments of the present disclosure, if the previous action group information is information for controlling the external device 200 based on a time, the electronic device 100 may wait for a specified time (e.g., a certain time defined in the previous action group information) without transmitting new action group information. Alternatively, if the previous action group information is information related to a location of the electronic device 100, the electronic device 100 may determine whether a specified condition related to a location is satisfied (e.g., whether the electronic device 100 enters a specified location or is outside the specified location).

According to various embodiments of the present disclosure, in relation to a request for confirmation, the electronic device 100 may output information for notifying that the external device 200 is being controlled according to the previous action group information. Furthermore, the electronic device 100 may output a confirmation window for confirming whether to stop controlling the external device 200 according to the previous action group information and control the external device 200 according to new action group information.

In operation 611, the electronic device 100 may determine whether a previous action ending input or a confirmation input is received. If an input signal related to an end of a previous action is not received or there is no confirmation input, the electronic device 100 may re-perform a previous operation, for example, operation 609. Alternatively, the electronic device 100 may regard a new action execution request as a failure after re-performing operation 609 a specified number of times or for a specified time.

If the previous action is ended or the confirmation input is received, the electronic device 100 may handle execution of a new action or execution of an action according to confirmation in operation 613. For example, the electronic device 100 may transmit new action group information to the management device 220.

According to the above-mentioned embodiments, an external device operating method according to an embodiment of the present disclosure may include outputting device objects corresponding to a plurality of external devices based on information related to control of the plurality of external devices and generating, when an input event for selecting a plurality of device objects is received, action group information by grouping pieces of action information related to an operation setting of each of selected device objects. The method may further include storing generated action group information.

According to the above-mentioned embodiments, an external device operating method according to an embodiment of the present disclosure may include outputting at least some of device objects based on information related to control of a plurality of external devices, receiving an input for selecting at least one device object from among the at least some of the device objects, and generating action group information related to control of selected external devices by grouping pieces of action information for instructing external devices corresponding to the selected at least one device object to perform a specified operation.

According to various embodiments of the present disclosure, the method may further include outputting an action group object corresponding to the action group information.

According to various embodiments of the present disclosure, the method may further include generating, when at least one device object not included in the action group information is selected, integrated action information by combining action information related to the selected at least one device object with the action group information.

According to various embodiments of the present disclosure, the method may further include outputting, when the action group object is selected, device objects respectively corresponding to a plurality of external devices related to the action group object.

According to various embodiments of the present disclosure, the method may further include updating the action group information according to a change in an operation setting of the device objects related to the action group object.

According to various embodiments of the present disclosure, the method may further include outputting at least one other action group information in response to an input event.

According to various embodiments of the present disclosure, the method may further include generating, when another action group object corresponding to the other action group information is selected, integrated action group information by combining the other action group object with the action group information.

According to various embodiments of the present disclosure, the method may further include determining priorities of the action group information and the other action group information in response to an input event.

According to various embodiments of the present disclosure, the method may further include determining priorities of the device objects in response to an input event.

According to various embodiments of the present disclosure, the method may further include determining a priority of the action group information in response to an input event.

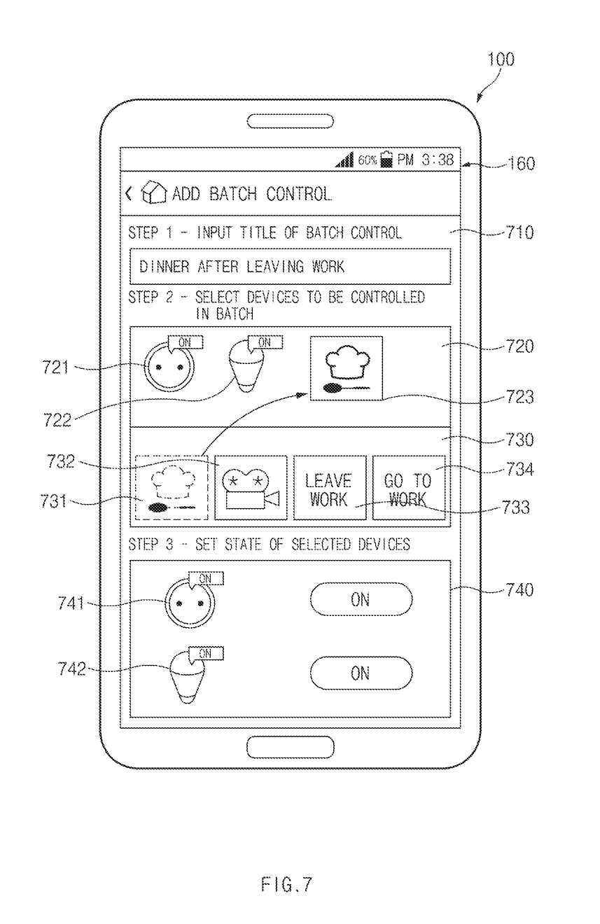

FIG. 7 is a diagram illustrating an example of a screen interface related to batch control during operation of an external device according to an embodiment of the present disclosure.

Referring to FIG. 7, a smart application related to integrated operation of the external device 200 is executed, the electronic device 100 may output an integrated operation screen to the display 160. The integrated operation screen may include, for example, a first title area 710, a selection area 720, a candidate area 730, and a state setting area 740.

The first title area 710 may represent an area for entering or displaying an action group name in response to a user input. Different action group names may be displayed according to a user input. Alternatively, the first title area 710 may output an action group name corresponding to previous action group information that is currently being executed by the management device 220. Alternatively, the first title area 710 may output an action group name corresponding to action group information most recently executed.

The selection area 720 may represent an area on which one or more device objects 721 and 722 included in an integrated action group or at least one action group object 723 is displayed. The device objects 721 and 722, for example, may be displayed as at least one of an image or a text corresponding to each of the external devices 210-1 to 210-N. When a device object is selected, information related to operation setting of the device object may be output to the state setting area 740. The action group object 723, for example, may represent an object corresponding to at least one action group information. The action group object 723 may include text information according to a user input, or may be provide as an image combination of combined device objects 721 and 722. Alternatively, the action group object 723 may be displayed as a specified image or text. According to an embodiment of the present disclosure, the selection area 720 may display device objects 721 and 722 in the form of a power object 721 and a lighting object 722. The power object 721 may represent an object corresponding to action information related to one external device, for example, a power supply of a specified location. The lighting object 722 may represent an object corresponding to action information related to one external device, for example, a lighting device of a specified location.

The candidate area 730 may include one or more other action group candidate objects 731 to 734. According to various embodiments of the present disclosure, the candidate area 730 may display one or more other device objects not belonging to the integrated action group. For example, the candidate area 730 may display a cooking candidate object 731, a movie candidate object 732, a leaving-work candidate object 733, and a going-to-work candidate object 734. A specified event occurs on the candidate area 730, other action group objects that are not shown may be displayed. The cooking candidate object 731, for example, may represent an object corresponding to action group information obtained by combining action information related to a lighting device of a kitchen, action information related to a rice cooker, and action information related to a microwave oven. The movie candidate object 732, for example, may represent an object corresponding to action group information obtained by combining action information related to a TV monitor, action information related to a speaker, and action information related to a lighting device. The going-to-work candidate object 734 or the leaving-work candidate object 733 may represent an object corresponding to action group information obtained by combining action information related to all lighting devices of a specified area (e.g., a home, an office, etc.), action information related to all power supplies of a specified area, and action information related to a locking device of a specified area.

In response to a user input, the cooking candidate object 731 disposed on the candidate area 730 may be moved to the selection area 720. Accordingly, the power object 721, the lighting object 722, and the cooking candidate object 731 may be arranged on the selection area 720. As the cooking candidate object 731 is moved, the movie candidate object 732, the leaving-work object 733, and the going-to-work candidate object 734 may be arranged on the candidate area 730.

The state setting area 740 may represent an area for displaying a state setting of the action group object 723 or one or more device objects 721 and 722 output to the selection area 720. The state setting area 740 may also represent an area for adjusting the state setting of the action group object 723 or the device objects 721 and 722. According to an embodiment of the present disclosure, in response to occurrence of an input event for selecting and adjusting a setting value of the action group object 723 or the device objects 721 and 722, the electronic device 100 may change device information and action group information related to the corresponding objects. The electronic device 100 may store changed device information and action group information. The electronic device 100 may transmit, to the management device, integrated action information corresponding to the changed device information and action group information in response to occurrence of a specified event.

Referring to FIG. 7, if the power object 721 and the lighting object 722 are arranged on the selection area 720, a power setting object 741 and a lighting setting object 742 may be displayed on the state setting area 740. If the cooking candidate object 731 is moved to the selection area 720, setting objects related to the cooking object 723 (e.g., a setting object of a kitchen lighting device, a setting object of a rice cooker, a setting object of a microwave oven, etc.) may be output to the state setting area 740. In case when the number of the setting objects is larger than a specified number, setting objects not shown may be displayed in response to a scroll input.

As described above, an external device operating function according to various embodiments of the present disclosure may support easy combination of action information corresponding to a single external device and action group information corresponding to a plurality of external devices.

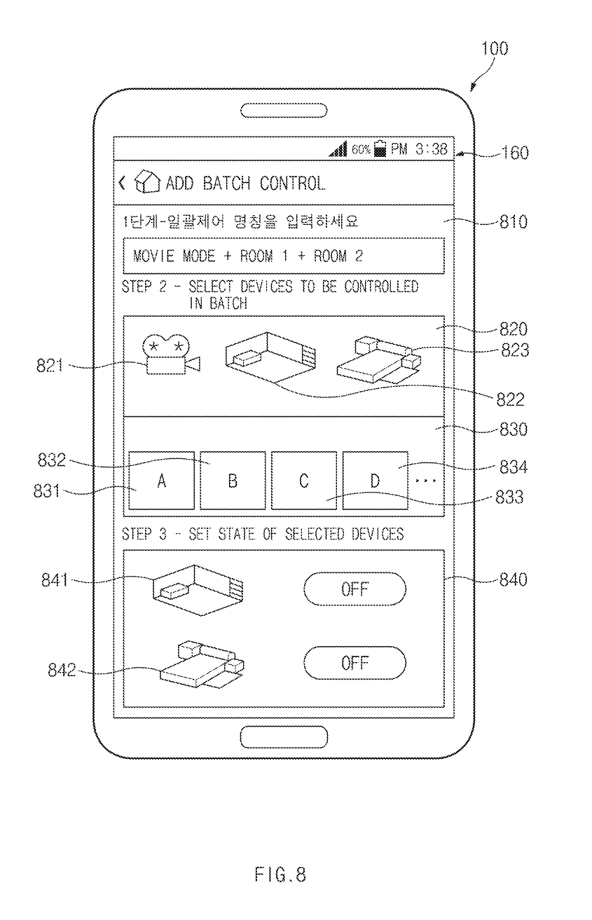

FIG. 8 is a diagram illustrating an example of a screen interface related to group control during operation of an external device according to an embodiment of the present disclosure.

Referring to FIG. 8, the electronic device 100 may output an integrated operation screen to the display 160. The integrated operation screen may include for example, a second title area 810, a group selection area 820, a group candidate area 830, and a group state setting area 840.

The second title area 810 may represent an area for displaying information corresponding to a name of an integrated action group. Alternatively, the second title area 810 may display another action group name according to a user input. For example, an auxiliary window including the other action group name may be output in relation to the second title area according to a user input. Alternatively, the second title area 810 may represent an area for entering an integrated action group name of pieces of action group information to be modified or newly generated. According to various embodiments of the present disclosure, the second title area 810 may represent an area for outputting an action group name corresponding to previous action group information or an action group name corresponding to action group information most recently executed.

The group selection area 820 may represent an area for outputting action group objects 821 to 823 corresponding to at least one selected action group information. For example, a movie object 821, a room 1 object 822, and a room 2 object 823 may be output to the group selection area 820. The movie object 821, for example, may represent an object corresponding to action group information obtained by combining action information related to a TV monitor, action information related to lighting, and action information related to a speaker. The room 1 object 822 or the room 2 object 823, for example, may represent an object corresponding to action group information obtained by combining pieces of action information of external devices (e.g., a lighting device, a temperature regulator, etc.) arranged in a room 1 or a room 2.

The group candidate area 830, for example, may represent an area for displaying candidate action group objects 831 to 834 corresponding to at least one action group information. The candidate action group objects 831 to 834, for example, may represent objects corresponding to pieces of action group information obtained by combining pieces of action information of a plurality of external devices. Specific candidate action group objects from among the candidate action group objects 831 to 834 may include duplicate action information for an external device.

The group state setting area 840 may represent an area for setting operation of the action group objects 821 to 823 arranged on the group selection area 820. For example, the group state setting area 840 may support operation setting related to a room 1 setting object 841 and operation setting related to a room 2 setting object 842. The room 1 setting object 841 or the room 2 setting object 842 may support setting for all external devices located in the room 1 or the room 2. Alternatively, the room 1 setting object 841 or the room 2 setting object 842 may support setting for each external device included in the room 1 or the room 2. In relation to this operation, if an input event related to selection of the room 1 setting object 841 occurs, the electronic device 100 may provide a setting screen for external devices related to the room 1. If an input event related to selection of the room 2 setting object 842 occurs, the electronic device 100 may provide a setting screen for external devices related to the room 2. According to various embodiments of the present disclosure, the group state setting area 840 may display a movie setting object related to the movie object 821 in response to occurrence of a specified input event (e.g., a scroll event). In relation to the movie setting object, the electronic device 100 may output an operation setting screen related to control of all external devices related to the movie object or may output an operation setting screen of each external device related to the movie object.

As described above, an external device operating function according to various embodiments of the present disclosure may support easy combination and operation setting of pieces of action group information. Specific external device action information or action group information of specific external devices may be changed according to an operation setting. Here, the action group information, for example, may include at least one of action group information for each scenario of external devices set according to a user input, action group information for each location of external devices located in a specified area, or action group information for each time of external devices selected according to a time.

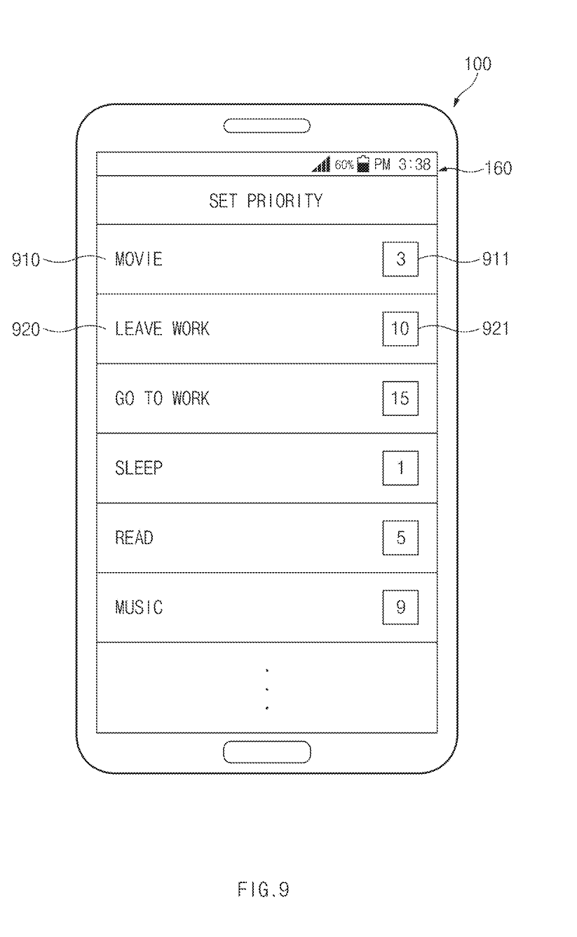

FIG. 9 is a diagram illustrating an example of a screen interface related to priority setting during operation of an external device according to an embodiment of the present disclosure.

Referring to FIG. 9, if an event related to priority setting occurs, the electronic device 100 may output a setting screen as illustrated in FIG. 9. The setting screen, for example, may include an area on which at least one action group object (or at least one device item) is displayed and a priority area for setting a priority of each action group object (or device item).

According to an embodiment of the present disclosure, a priority of a movie object 910 may be set as 3 as illustrated in FIG. 9. In relation to this operation, the setting screen may include a movie priority information area 911. A leaving-work object 920 may have a value of 10 as shown in a leaving-work priority information area 921.

As described above, the priority of the movie object 910 may be higher than that of the leaving-work object 920. In this case, duplicate action information of an external device from among pieces of action group information respectively corresponding to the movie object 910 and the leaving-work object 920 may be controlled according to the action information of the movie object 910. For example, action information corresponding to turning off a living room lighting device may be included in the action group information corresponding to the movie object 910, and action information corresponding to turning on the living room lighting device may be included in the action group information corresponding to the leaving-work object 920. Furthermore, movie/leaving-work integrated action group information obtained by combining the action group information corresponding to the movie object 910 and the action group information corresponding to the leaving-work object 920 may be set. In this case, if execution of the movie/leaving-work integrated action group information is requested, the electronic device 100 may transmit, to the management device 200, the action information included in the movie action group information, with respect to lighting device-related action information in the movie/leaving-work integrated action group information.

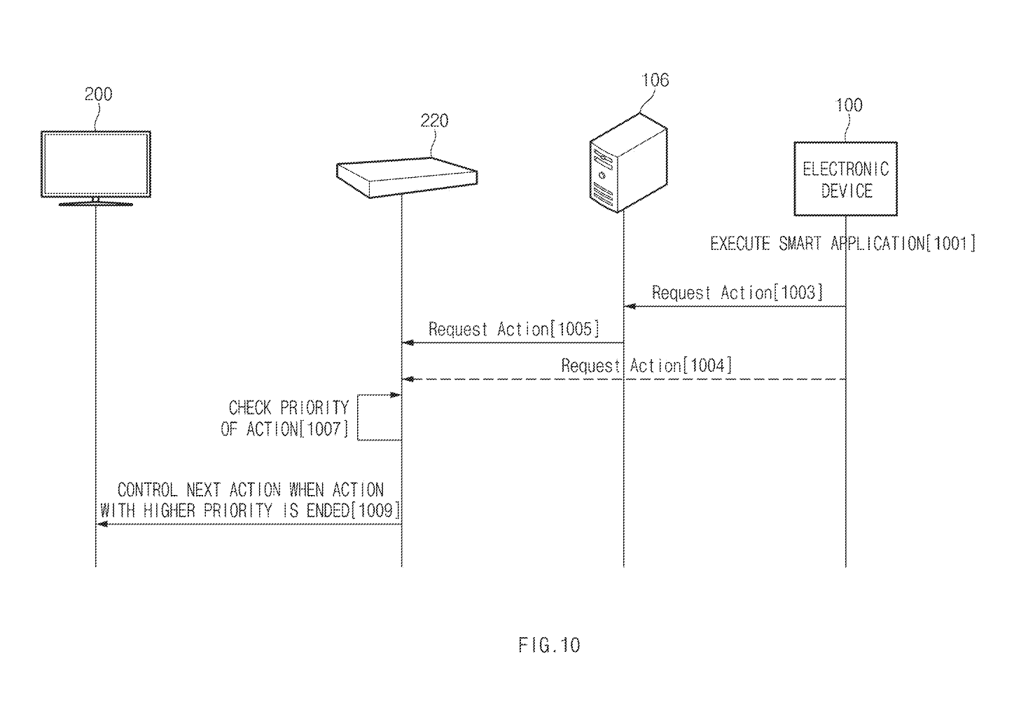

FIG. 10 is a system diagram illustrating an example of a signal flow related to execution of an action considering a conflict between actions during operation of an external device according to an embodiment of the present disclosure.

Referring to FIG. 10, the integrated operation system 10 related to operation of the external device may include the electronic device 100, a server 106, the management device 220, and the external device 200. The server 106, for example, may be a cloud server or a server capable of accessing the management device. The management device may be a hub or a gateway connected to external devices.

In relation to operation of the external device, the electronic device 100 may execute a smart application that supports integrated operation of external devices in response to a user input or arrival of a specified schedule, in operation 1001. In operation 1003, the electronic device 100 may send, to the server 106, a request for an action selected by the user input or an action selected in response to arrival of the specified schedule. In relation to this operation, the electronic device 100 may be connected to the server 106 via the network. In relation to the request for the action, the electronic device 100 may transmit action group information to the server 106. In operation 1005, the server 106 may send a request for a selected action to the management device 220. According to various embodiments of the present disclosure, the electronic device 100 may directly send a request for the selected action to the management device 220 without sending the request via the server 106, as shown in operation 1004.

In operation 1007, the management device 220 may check a priority of the requested action. For example, the management device 220 may check whether there exists duplicate action information for the same external device from among pieces of integrated action group information. If duplicate action information exists, the management device 220 may control the external device by selecting action information belonging to action group information having a higher priority.

According to various embodiments of the present disclosure, the management device 220 may check a priority of the action group information transmitted by the electronic device 100. The management device 220 may determine a priority of action group information that is currently being applied in relation to control of the external device. In relation to this operation, the electronic device 100 may transmit priority information of action group information to the management device 220. The management device 220 may perform handling so that action group information having a higher priority is applied.

If control of the external device 200 according to the action group information having a higher priority is ended, the management device 220 may perform next action control in operation 1009. In relation to this operation, the management device 220 may temporarily store received action group information, and may monitor whether control of the external device 200 according to currently applied action group information is ended. An end of the control of the external device 200 may include a manual end of the control of the external device 200 or an end of the control of the external device 200 in response to satisfaction of a specified condition.

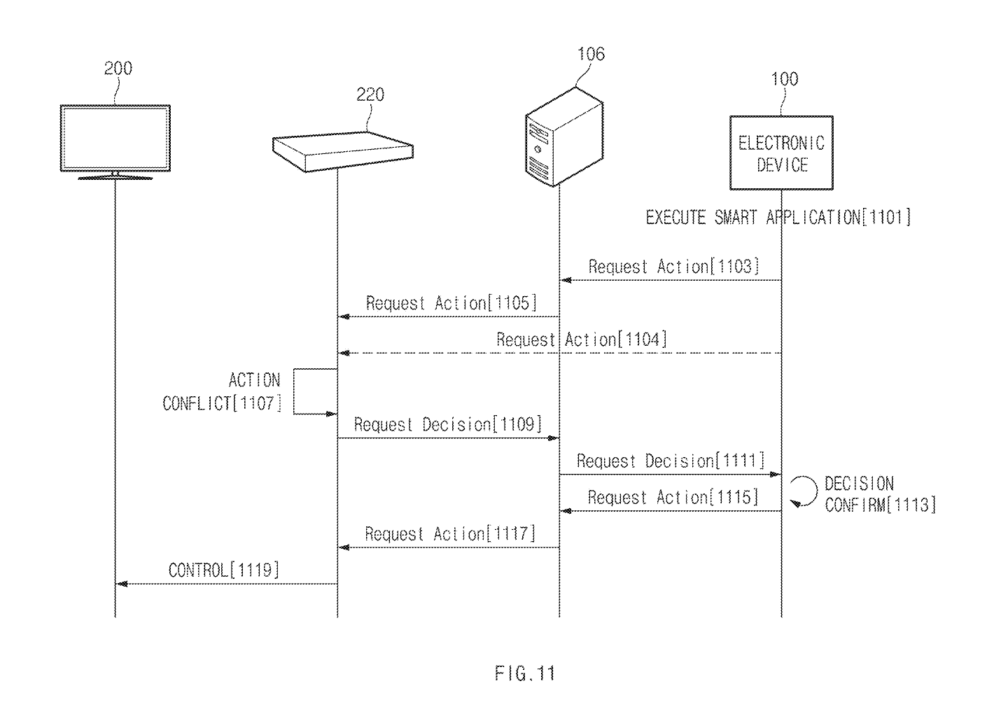

FIG. 11 is a system diagram illustrating another example of a signal flow related to execution of an action considering a conflict between actions during operation of an external device according to an embodiment of the present disclosure.

Referring to FIG. 11, the integrated operation system 10 related to operation of the external device may include the electronic device 100, the server 106, the management device 220, and the external device 200.

In relation to operation of the external device, the electronic device 100 may execute a smart application that supports integrated operation of the external device 200 in response to a user input or arrival of a specified schedule, in operation 1101. If an action request related to integrated operation of the external device 200 occurs, the electronic device 100 may send, to the server 106, a request for an action selected by the user input or an action selected in response to arrival of the specified schedule, in operation 1103. In relation to the request for an action, the electronic device 100 may transmit action group information to the server 106. In operation 1105, the server 106 may transfer a selected action to the management device 220. In this operation, the server 106 may transfer, to the management device 220, the action group information provided from the electronic device 100. According to various embodiments of the present disclosure, the electronic device 100 may directly request (or transmit) the selected action (or the action group information) from (or to) the management device 220 without requesting (or transmitting) the selected action (or the action group information) via the server 106, as shown in operation 1104.

In operation 1107, the management device 220 may determine an action conflict. For example, the management device 220 may determine whether pieces of integrated action group information provided from the electronic device 100 include pieces of action information which conflict with each other. For example, the management device 220 may determine whether action information related to external devices (e.g., a lighting device) is provided in plurality. The management device 220 may determine whether a plurality of pieces of action information request different operations. If there exist pieces of action information which request different operations with respect to the same external device, the management device 220 may determine that there is an action conflict.

If it is determined that there is an action conflict, the electronic device 100 may transmit a decision request to the server 106 in operation 1109. In operation 1111, the server 106 may transfer the decision request to the electronic device 100. In operation 1113, the electronic device 100 may output a confirmation window for receiving a user's decision. In operation 1115, the electronic device 100 may transmit, to the server 106, a user selection action according to the user's decision. In operation 1117, the server 106 may transfer the user selection action to the management device 220. The user selection action, for example, may be selection information about action information of a specific external device.

According to various embodiments of the present disclosure, the management device 220 may directly transfer the decision request to the electronic device 100. The electronic device 100 may directly transfer the user selection action to the management device 220 without transferring the user selection action via the server 106.

In operation 1119, the management device 220 may transfer, to the external device 200, action group information including action information corresponding to the user selection action. The external device 200 may operate according to the action group information.

Although the above description is provided on the assumption that the management device 220 and the server 106 are arranged as individual elements, various embodiments of the present disclosure are not limited thereto. In various embodiments of the present disclosure, the management device 220 may have a function of the server 106 so that the server 106 may not be provided. Alternatively, a system is provided such that the server 106 replaces the management device 220 and includes an interface connected to the external devices 200. In the following description, device registration of an application and interworking with the external device 200 are described with respect to the management device 220.

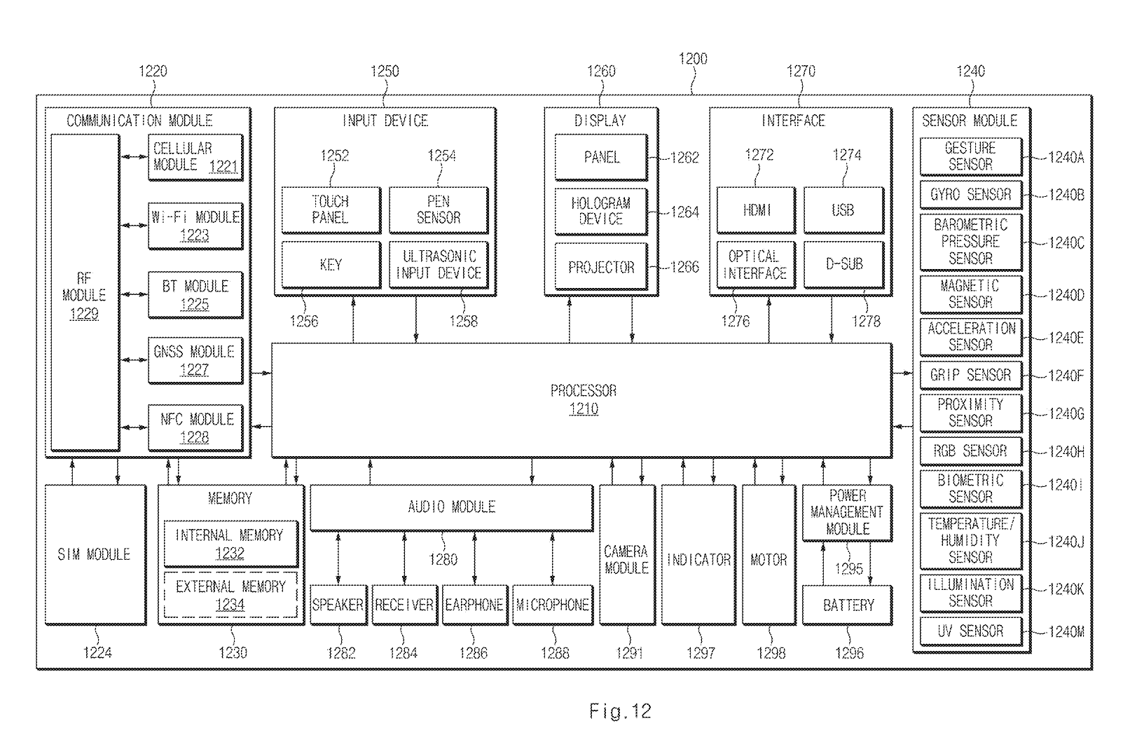

FIG. 12 is a block diagram illustrating an electronic device according to an embodiment of the present disclosure.

Referring to FIG. 12, an electronic device 1200 may include, for example, a part or the entirety of the electronic device described above with respect to the above-mentioned various embodiments of the present disclosure. The electronic device 1200 may include at least one processor (e.g., a processor) 1210, a communication module 1220, a subscriber identification module 1224, a memory 1230, a sensor module 1240, an input device 1250, a display 1260, an interface 1270, an audio module 1280, a camera module 1291, a power management module 1295, a battery 1296, an indicator 1297, and a motor 1298.

The processor 1210 may run an operating system (OS) or an application program so as to control a plurality of hardware or software elements connected to the processor 1210, and may process various data and perform operations. The processor 1210 may be implemented with, for example, a system on chip (SoC). According to an embodiment of the present disclosure, the processor 1210 may further include a graphic processing unit (GPU) and/or an image signal processor (ISP). The processor 1210 may include at least a portion (e.g., a cellular module 1221) of the elements illustrated in FIG. 12. The processor 1210 may load, on a volatile memory, an instruction or data received from at least one of other elements (e.g., a nonvolatile memory) to process the instruction or data, and may store various data in a nonvolatile memory.

The communication module 1220 may have a configuration that is the same as or similar to that of the communication interface 170 of FIG. 1. The communication module 1220 may include, for example, a cellular module 1221, a Wi-Fi module 1223, a Bluetooth module 1225, a GNSS module 1227 (e.g., a GPS module, a GLONASS module, a BeiDou module, or a Galileo module), a near field communication (NFC) module 1228, and a radio frequency (RF) module 1229. In addition, the communication module 1220 may further include an MST module.

The cellular module 1221 may provide, for example, a voice call service, a video call service, a text message service, or an Internet service through a communication network. According to an embodiment of the present disclosure, the cellular module 1221 may identify and authenticate the electronic device 1200 in the communication network using the subscriber identification module 1224 (e.g., a subscriber identity module (SIM) card). According to an embodiment of the present disclosure, the cellular module 1221 may perform at least a part of functions providable by the processor 1210. According to an embodiment of the present disclosure, the cellular module 1221 may include a communication processor (CP).

Each of the Wi-Fi module 1223, the BT module 1225, the GNSS module 1227, and the NFC module 1228 may include, for example, a processor for processing data transmitted/received through the modules. According to some various embodiments of the present disclosure, at least a portion (e.g., at least two) of the cellular module 1221, the Wi-Fi module 1223, the BT module 1225, the GNSS module 1227, and the NFC module 1228 may be included in a single integrated chip (IC) or IC package.

The RF module 1229 may transmit/receive, for example, communication signals (e.g., RF signals). The RF module 1229 may include, for example, a transceiver, a power amp module (PAM), a frequency filter, a low noise amplifier (LNA), an antenna, or the like. According to another embodiment of the present disclosure, at least one of the cellular module 1221, the Wi-Fi module 1223, the BT module 1225, the GNSS module 1227, or the NFC module 1228 may transmit/receive RF signals through a separate RF module.

The subscriber identification module 1224 may include, for example, an embedded SIM and/or a card containing a subscriber identity module, and may include unique identification information (e.g., an integrated circuit card identifier (ICCID)) or subscriber information (e.g., international mobile subscriber identity (IMSI)).

The memory 1230 (e.g., the memory 130) may include an internal memory 1232 or an external memory 1234. The internal memory 1232 may include at least one of a volatile memory (e.g., a dynamic RAM (DRAM), a static RAM (SRAM), a synchronous dynamic RAM (SDRAM), or the like) or a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like), a hard drive, or a solid state drive (SSD)).

The external memory 1234 may include a flash drive, for example, compact flash (CF), secure digital (SD), micro secure digital (Micro-SD), mini secure digital (Mini-SD), extreme digital (xD), multi-media card (MMC), a memory stick, or the like. The external memory 1234 may be operatively and/or physically connected to the electronic device 1200 through various interfaces.

The electronic device may further include a security module. The security module, which is a high-security module compared to the memory 1230, may be a circuit that guarantees secure storage of data and a protected execution environment. The security module may be implemented with a separate circuit, and may include a separate processor. The security module may include, for example, an embedded secure element (eSE) embedded in a fixed chip of the electronic device 1200 or present in a detachable smart chip or secure digital (SD) card. The security module may be driven by an OS different from an OS of the electronic device 1200. For example, the security module may be operated based on a java card open platform (JCOP) OS.

The sensor module 1240 may, for example, measure physical quantity or detect an operation state of the electronic device 1200 so as to convert measured or detected information into an electrical signal. The sensor module 1240 may include, for example, at least one of a gesture sensor 1240A, a gyro sensor 1240B, a barometric pressure sensor 1240C, a magnetic sensor 1240D, an acceleration sensor 1240E, a grip sensor 1240F, a proximity sensor 1240G, a color sensor 1240H (e.g., a red/green/blue (RGB) sensor), a biometric sensor 1240I, a temperature/humidity sensor 1240J, an illumination sensor 1240K, or an ultraviolet (UV) sensor 1240M. Additionally or alternatively, the sensor module 1240 may include, for example, an olfactory sensor (E-nose sensor), an electromyography (EMG) sensor, an electroencephalogram (EEG) sensor, an electrocardiogram (ECG) sensor, an infrared (IR) sensor, an iris sensor, and/or a fingerprint sensor. The sensor module 1240 may further include a control circuit for controlling at least one sensor included therein. In some various embodiments of the present disclosure, the electronic device 1200 may further include a processor configured to control the sensor module 1240 as a part of the processor 1210 or separately, so that the sensor module 1240 is controlled while the processor 1210 is in a sleep state.

The input device 1250 may include, for example, a touch panel 1252, a (digital) pen sensor 1254, a key 1256, or an ultrasonic input device 1258. The touch panel 1252 may employ at least one of capacitive, resistive, infrared, and ultraviolet sensing methods. The touch panel 1252 may further include a control circuit. The touch panel 1252 may further include a tactile layer so as to provide a haptic feedback to a user.

The (digital) pen sensor 1254 may include, for example, a sheet for recognition which is a part of a touch panel or is separate. The key 1256 may include, for example, a physical button, an optical button, or a keypad. The ultrasonic input device 1258 may sense ultrasonic waves generated by an input tool through a microphone (e.g., a microphone 1288) so as to identify data corresponding to the ultrasonic waves sensed.

The display 1260 (e.g., the display 160) may include a panel 1262, a hologram device 1264, or a projector 1266. The panel 1262 may have a configuration that is the same as or similar to that of the display 160 of FIG. 2. The panel 1262 may be, for example, flexible, transparent, or wearable. The panel 1262 and the touch panel 1252 may be integrated into a single module. The hologram device 1264 may display a stereoscopic image in a space using a light interference phenomenon. The projector 1266 may project light onto a screen so as to display an image. The screen may be disposed in the inside or the outside of the electronic device 1200.

According to an embodiment of the present disclosure, the display 1260 may further include a control circuit for controlling the panel 1262, the hologram device 1264, or the projector 1266.

The interface 1270 may include, for example, an HDMI 1272, a USB 1274, an optical interface 1276, or a D-subminiature (D-sub) 1278. The interface 1270, for example, may be included in the communication interface 170 illustrated in FIG. 1. Additionally or alternatively, the interface 1270 may include, for example, a mobile high-definition link (MHL) interface, an SD card/MMC interface, or an infrared data association (IrDA) interface.

The audio module 1280 may convert, for example, a sound into an electrical signal or vice versa. At least a portion of elements of the audio module 1280 may be included in the input/output interface 150 illustrated in FIG. 1. The audio module 1280 may process sound information input or output through a speaker 1282, a receiver 1284, an earphone 1286, or the microphone 1288.

According to an embodiment of the present disclosure, the camera module 1291 for shooting a still image or a video may include, for example, at least one image sensor (e.g., a front sensor or a rear sensor), a lens, an ISP, or a flash (e.g., an LED or a xenon lamp).

The power management module 1295 may manage power of the electronic device 1200. According to an embodiment of the present disclosure, the power management module 1295 may include a power management integrated circuit (PMIC), a charger integrated circuit (IC), or a battery or fuel gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1296 and a voltage, current or temperature thereof while the battery is charged. The battery 1296 may include, for example, a rechargeable battery and/or a solar battery.

The indicator 1297 may display a specific state of the electronic device 1200 or a part thereof (e.g., the processor 1210), such as a booting state, a message state, a charging state, or the like. The motor 1298 may convert an electrical signal into a mechanical vibration, and may generate a vibration or haptic effect. Although not illustrated, a processing device (e.g., a GPU) for supporting a mobile TV may be included in the electronic device 1200. The processing device for supporting a mobile TV may process media data according to the standards of digital multimedia broadcasting (DMB), digital video broadcasting (DVB), MediaFLO™, or the like.

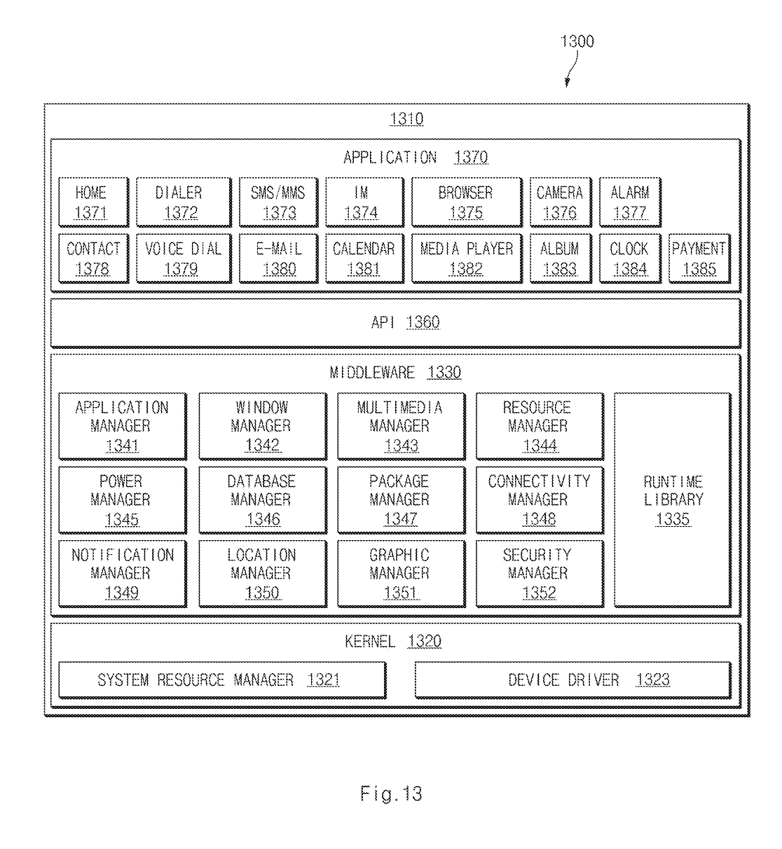

FIG. 13 is a diagram illustrating a program block 1300 according to an embodiment of the present disclosure.

Referring to FIG. 13, a program module 1310 (e.g., the program 140) according to various embodiments of the present disclosure may include an OS for controlling a resource related to an electronic device (e.g., the electronic device 100) and/or various applications (e.g., the application program 147) running on the OS. The OS may be, for example, Android, iOS, Windows, Symbian, Tizen, Bada, or the like.

The program module 1310 may include a kernel 1320, a middleware 1330, an API 1360, and/or an application 1370. At least a part of the program module 1310 may be preloaded on an electronic device or may be downloaded from a server (e.g., an electronic device 104 or the server 106).

The kernel 1320 (e.g., the kernel 141) may include, for example, a system resource manager 1321 and/or a device driver 1323. The system resource manager 1321 may perform control, allocation, or retrieval of a system resource. According to an embodiment of the present disclosure, the system resource manager 1321 may include a process management unit, a memory management unit, a file system management unit, or the like. The device driver 1323 may include, for example, a display driver, a camera driver, a Bluetooth driver, a shared memory driver, a USB driver, a keypad driver, a Wi-Fi driver, an audio driver, or an inter-process communication (IPC) driver.

The middleware 1330, for example, may provide a function that the applications 1370 require in common, or may provide various functions to the applications 1370 through the API 1360 so that the applications 1370 may efficiently use limited system resources in the electronic device. According to an embodiment of the present disclosure, the middleware 1330 (e.g., the middleware 143) may include at least one of a runtime library 1335, an application manager 1341, a window manager 1342, a multimedia manager 1343, a resource manager 1344, a power manager 1345, a database manager 1346, a package manager 1347, a connectivity manager 1348, a notification manager 1349, a location manager 1350, a graphic manager 1351, or a security manager 1352.

The runtime library 1335 may include, for example, a library module that a complier uses to add a new function through a programming language while the application 1370 is running. The runtime library 1335 may perform a function for input/output management, memory management, or an arithmetic function.

The application manager 1341 may mange, for example, a life cycle of at least one of the applications 1370. The window manager 1342 may manage a graphical user interface (GUI) resource used in a screen. The multimedia manager 1343 may recognize a format required for playing various media files and may encode or decode a media file using a codec matched to the format. The resource manager 1344 may manage a resource such as a source code, a memory, or a storage space of at least one of the applications 1370.

The power manager 1345, for example, may operate together with a basic input/output system (BIOS) to manage a battery or power and may provide power information required for operating the electronic device. The database manager 1346 may generate, search, or modify a database to be used in at least one of the applications 1370. The package manager 1347 may manage installation or update of an application distributed in a package file format.

The connectivity manger 1378 may manage wireless connection of Wi-Fi, Bluetooth, or the like. The notification manager 1349 may display or notify an event such as message arrival, appointments, and proximity alerts in such a manner as not to disturb a user. The location manager 1350 may manage location information of the electronic device. The graphic manager 1351 may manage a graphic effect to be provided to a user or a user interface related thereto. The security manager 1352 may provide various security functions required for system security or user authentication. According to an embodiment of the present disclosure, in the case in which an electronic device (e.g., the electronic device 100) includes a phone function, the middleware 1330 may further include a telephony manager for managing a voice or video call function of the electronic device. The payment manager 1354 may relay information for payment from the application 1370 to another application 1370 or the kernel 1320. Furthermore, the payment manager 1354 may store, in the electronic device, payment information received from external device, or may transfer information stored therein to the external device.

The middleware 1330 may include a middleware module for forming a combination of various functions of the above-mentioned elements. The middleware 1330 may provide a module specialized for each type of an OS to provide differentiated functions. Furthermore, the middleware 1330 may delete a part of existing elements or may add new elements dynamically.

The API 1360 (e.g., the API 145) which is, for example, a set of API programming functions, may be provided in different configurations according to an OS. For example, in the case of Android or iOS, one API set may be provided for each platform, and, in the case of Tizen, at least two API sets may be provided for each platform.

The application 1370 (e.g., the application program 147), for example, may include at least one application for performing functions such as a home 1371, a dialer 1372, a short message service (SMS)/multimedia message service (MMS) 1373, an instant message (IM) 1374, a browser 1375, a camera 1376, an alarm 1377, a contact 1378, a voice dial 1379, an e-mail 1380, a calendar 1381, a media player 1382, an album 1383, a clock 1384, a payment 1385, health care (e.g., measure an exercise amount or blood sugar), or environmental information provision (e.g., provide air pressure, humidity, or temperature information).

According to an embodiment of the present disclosure, the application 1370 may include an application (hereinafter referred to as an “information exchange application” for convenience) for supporting information exchange between the electronic device (e.g., the electronic device 100) and the server 106 (e.g., the electronic device 104). The information exchange application may include, for example, a notification relay application for relaying specific information to an external device or a device management application for managing an external electronic device or an external device.

For example, the notification relay application may have a function for relaying, to an external electronic device (e.g., the external device 200), notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of the external device itself (or some elements) or the brightness (or resolution) adjustment of a display) of the external device 200 communicating with the electronic device, an application running in the external device, or a service (e.g., a call service or a message service) provided from the external device.

According to an embodiment of the present disclosure, the application 1370 may include a specified application (e.g., a healthcare application of a mobile medical device) according to an attribute of the external device 200. According to an embodiment of the present disclosure, the application 1370 may include an application received from the external device 200, the server 106, or the management device 220. According to an embodiment of the present disclosure, the application 1370 may include a preloaded application or a third-party application downloadable from a server. The names of the elements of the program module 1310 illustrated may vary with the type of an OS.

According to various embodiments of the present disclosure, at least a part of the program module 1310 may be implemented with software, firmware, hardware, or a combination thereof. At least a part of the program module 1310, for example, may be implemented (e.g., executed) by a processor (e.g., the processor 120). At least a part of the program module 1310 may include, for example, a module, a program, a routine, sets of instructions, or a process for performing at least one function.

Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one software module for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

According to various embodiments of the present disclosure, a plurality of external devices connected to a hub or a server may be controlled through one integrated operation interface.

Furthermore, according to various embodiments of the present disclosure, pieces of action information related to operation control of each external device may be operated in groups.

Moreover, according to various embodiments of the present disclosure, new action group information generation or modification may be performed with ease using a combination or modification of one or more pieces of action group information or a combination of action group information and action information of a specific external device.

In addition, according to various embodiments of the present disclosure, an external device may be controlled more rationally by setting priorities of pieces of action group information.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a memory for storing device objects corresponding to a plurality of external devices; and
a processor operatively connected to the memory,
wherein the processor is configured to:
output at least one of the device objects;
receive an input for selecting at least one device object from among the output at least one of the device objects; and
generate first action group information related to control of selected at least one of the external devices by grouping pieces of action information set to cause the at least one of the external devices corresponding to the at least one device object selected in response to the input to perform a specified operation.

2. The electronic device of claim 1, wherein the processor is configured to output a first action group object corresponding to the first action group information.

3. The electronic device of claim 2, wherein, upon receiving an additional input for selecting at least one device object not included in the first action group information, the processor is configured to generate integrated action information by combining action information related to the selected at least one device object with the first action group information according to the additional input.

4. The electronic device of claim 2, wherein the processor is configured to output, when the first action group object is selected, the device objects respectively corresponding to the plurality of external devices related to the first action group object.

5. The electronic device of claim 4, wherein the processor is configured to update the first action group information according to a change in an operation setting of the device objects related to the first action group object.

6. The electronic device of claim 2, wherein the processor is configured to output a second action group object corresponding to second action group information in response to an input event.

7. The electronic device of claim 6, wherein, when the second action group object is selected, the processor is configured to integrate the second action group information with the first action group information.

8. The electronic device of claim 7, wherein the processor is configured to determine priorities of the first action group information and the second action group information in response to an input event.

9. The electronic device of claim 1, wherein the processor is configured to determine priorities of the device objects in response to an input event.

10. The electronic device of claim 1, wherein the processor is configured to determine a priority of the first action group information in response to an input event.

11. An external device operating method comprising:
outputting, by an electronic device, at least one of device objects based on information related to control of a plurality of external devices;
receiving, by the electronic device, an input for selecting at least one device object from among the output at least one of the device objects; and
generating, by the electronic device, first action group information related to control of selected at least one of external devices by grouping pieces of action information set to cause external devices corresponding to the selected at least one device object to perform a specified operation.

12. The external device operating method of claim 11, further comprising generating, when an additional input for selecting at least one device object not included in the first action group information is received, integrated action information by combining action information related to an additionally selected device object with the first action group information.

13. The external device operating method of claim 11, further comprising outputting a first action group object corresponding to the first action group information.

14. The external device operating method of claim 13, further comprising outputting, when the first action group object is selected, device objects respectively corresponding to a plurality of external devices related to the first action group object.

15. The external device operation method of claim 13, further comprising updating the first action group information according to a change in an operation setting of device objects related to the first action group object.

16. The external device operating method of claim 13, further comprising:
outputting second action group information in response to an input event; and
generating, when a second action group object corresponding to the second action group information is selected, integrated action group information by combining the second action group object with the first action group information.

17. The external device operating method of claim 16, further comprising at least one of:
determining priorities of the first action group information and the second action group information in response to an input event;
determining priorities of the device objects in response to an input event; or
determining a priority of the action group information in response to an input event.

18. An electronic device comprising:
a memory for storing information corresponding to a first device group comprising at least one external device configured to perform a first function in association with the first device group; and
a processor operatively connected to the memory, wherein the processor is configured to:
receive a request for performing a second function by the at least one external device;
select at least one of the first function or the second function based on at least the information corresponding to the first device group in response to the request received; and
transmit a command for performing at least one of the first function or the second function to the at least one external device.

19. The electronic device of claim 18, wherein the second function comprises a function to be executed in association with a second device group comprising the at least one external device.

20. The electronic device of claim 19, wherein the processor is configured to select the at least one function further based on a level of contribution of the first function relative to an action to be performed by the first device group and a level of contribution of the second function relative to a second group action to be performed by the second device group.
